(19) United States
(12) Patent Application Publication
(10) Pub. No.: US 2026/0268180 A1
(43) Pub. Date: Sep. 10, 2026

(54) SYSTEMS AND METHODS FOR A DUAL-LAYER KNOWLEDGE GRAPH FRAMEWORK OF RETRIEVAL AUGMENTED GENERATION

(71) Applicant: Salesforce, Inc., San Francisco, CA (US)

(72) Inventors: Shilpa Bhagavath, Mountain View, CA (US); Prafulla Kumar Choubey, San Jose, CA (US); Zachary Alexander, Berkeley, CA (US); Shashank Harinath, Mountain View, CA (US); Katherine Tan, Bellevue, WA (US); Chien-Sheng Wu, Mountain View, CA (US); Sitaram Asur, Newark, CA (US); Shankha Dey, Bellevue, WA (US); Shankar Natarajan, Bangalore (IN); Henry Wallace, Frederick, MD (US)

(21) Appl. No.: 19/661,364

(22) Filed: Apr. 28, 2026

Related U.S. Application Data
(63) Continuation-in-part of application No. 19/006,731, filed on Dec. 31, 2024.

(30) Foreign Application Priority Data
Sep. 30, 2025 (IN) 202541093986

(51) Int. Cl. G06N 5/04; G06F 40/205; G06N 5/02

(52) U.S. Cl. CPC G06N 5/04; G06F 40/205; G06N 5/02

(57) ABSTRACT

Embodiments described herein provide a method of an artificial intelligence (AI) agent generating a response to a natural language query using a dual-layer knowledge graph. The method includes constructing a first knowledge graph by extracting a plurality of entities, propositions and/or relationships from at least one document. The method also includes constructing a second knowledge graph based on the at least one document, the first node and the second node from the first knowledge graph, and a pre-defined ontology structure, wherein the second knowledge graph comprises nodes and edges according to the pre-defined ontology structure. In response to the natural language query, a subset of propositions is retrieved from both the first knowledge graph and the second knowledge graph. A response is generated based on the query and context information corresponding to the subset of propositions, and the response is displayed at a visualized user interface of the AI agent.

### CROSS REFERENCE(S)

The instant application is a continuation in part of co-pending and commonly-owned U.S. nonprovisional application Ser. No. 19/006,731, filed Dec. 31, 2024, which is hereby expressly incorporated herein by reference in its entirety.

The instant application is a nonprovisional of and claims priority under 35 U.S.C. 119 to Indian Provisional Application No. 202541093986, filed Sep. 30, 2025, which is hereby expressly incorporated by reference herein in its entirety.

### TECHNICAL FIELD

The embodiments relate generally to machine learning systems for generative artificial intelligence (AI), and more specifically to systems and methods for a dual-layer knowledge graph framework of retrieval augmented generation.

### BACKGROUND

AI agents, commonly known as AI agents or virtual assistants, can be applied to a wide range of practical applications across various industries. In customer service, AI agents can handle user inquiries, provide support, and resolve issues 24/7, improving customer satisfaction and reducing operational costs. In healthcare, AI agents can offer initial consultations, answer health-related questions, and remind patients to take their medications. In the e-commerce sector, AI agents can assist with product recommendations, order tracking, and personalized shopping experiences. In information technology (IT) support, these agents can guide users through troubleshooting steps, helping them resolve software and hardware issues. Specifically, for network hazards, AI agents can diagnose connectivity problems, suggest corrective actions, and provide step-by-step guidance to ensure network security and stability. Their versatility and ability to handle diverse tasks make them valuable tools in enhancing efficiency and user experience in various fields.

AI agents often employ a neural network based generative language model to generate an output such as in the form of a text response, or a series actions to complete a complex task, such as to network issue troubleshooting, etc. Such generative language model receives a natural language input in the form of a sequence of tokens, and in turn generates a predicted distribution over a token space conditioned on the input sequence. Generated output tokens over time may in turn form the text response, or actions for completing the task. Some AI agents may adopt a retrieval augmented regeneration (RAG) system to generate an output, e.g., to retrieve a relevant context relating to an input query, and append the relevant context as part of the input for the AI agent to generate a response. However, retrieving the right context for efficient response generation remains challenging.

### BRIEF DESCRIPTION OF THE DRAWINGS

FIG. 1 illustrates an example operation of an LLM based AI agent, according to embodiments of the present disclosure.

FIG. 2 is a simplified diagram illustrating a pipeline for knowledge graph construction in the dual-layer knowledge graph framework, according to some embodiments.

FIGS. 3A and 3B show examples of ontology used in constructing a knowledge graph, according to some embodiments.

FIG. 4 is a simplified diagram illustrating a dual-layer knowledge graph framework, according to some embodiments.

FIG. 5 shows a detailed structure of the dual-layer knowledge graph framework of FIG. 4, according to some embodiments.

FIGS. 6A and 6B show retrievals by the dual-layer knowledge graph framework, according to some embodiments.

FIG. 7A is a simplified diagram illustrating a computing device implementing the dual-layer knowledge graph framework described in FIGS. 1-6B, according to some embodiments.

FIG. 7B is a simplified diagram illustrating a neural network structure, according to some embodiments.

FIG. 8 is a simplified block diagram of a networked system suitable for implementing the dual-layer knowledge graph framework described in FIGS. 1-7B and other embodiments described herein.

FIGS. 9A and 9B are example logic flow diagrams illustrating a method of generating answer for a user query based on the framework shown in FIGS. 1-8, according to some embodiments.

FIGS. 10, 11A-11E, 12, 13A, 13B, 14, and 15 provide example prompt instructions for executing certain operations in the dual-layer knowledge graph framework, according to some embodiments.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

In one embodiment, the term “network” may comprise any hardware or software-based framework that includes any artificial intelligence network or system, neural network or system and/or any training or learning models implemented thereon or therewith.

In one embodiment, the term “module” may comprise hardware or software-based framework that performs one or more functions. In some embodiments, the module may be implemented on one or more neural networks.

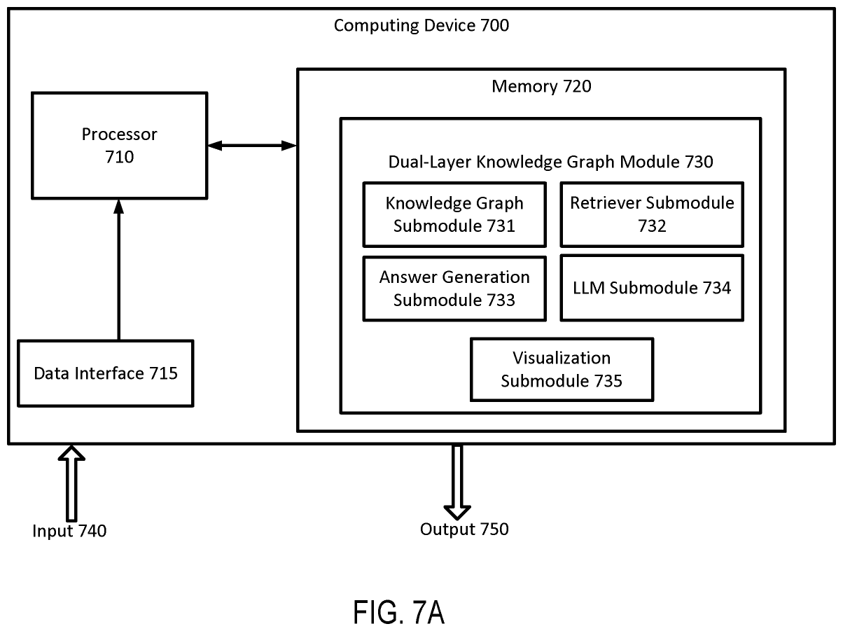

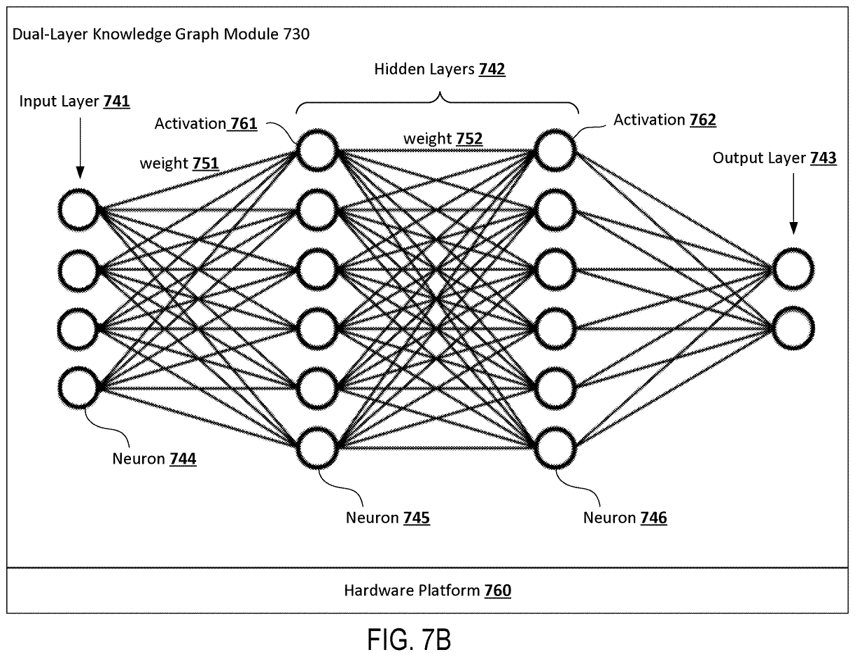

In one embodiment, the term “Transformer” may refer to an architecture of a deep learning model designed to process sequential data, such as text, using a mechanism called self-attention. The Transformer architecture handles an entire input sequence of tokens (such as words, letters, symbols, etc.) in parallel, and often generate an output sequence of tokens sequentially. The Transformer architecture may comprise a stack of Transformer layers, each of which contains a self-attention module to weigh the importance of each token relative to other tokens in the sequence and a feed-forward module to further transform the data. Additional details of how a Transformer neural network model processes input data to generate an output is provided in relation to FIG. 7B

In one embodiment, the term “Large Language Model” (LLM) may refer to a neural network based deep learning system designed to understand and generate human languages. An LLM may adopt a Transformer architecture that often entails a significant amount of parameters (neural network weights) and computational complexity. For example, LLM such as Generative Pre-trained Transformer (GPT) 3 has 175 billion parameters, Text-to-Text Transfer Transformers (T5) has around 11 billion parameters. An LLM may comprise an architecture of mixed software and/or hardware, e.g., including an application-specific integrated circuit (ASIC) such as a Tensor Processing Unit (TPU).

In one embodiment, the term “generative artificial intelligence (AI)” may refer to an AI system that outputs new content that does not pre-exist in the input to such AI system. The new content may include text, images, music, or code. An LLM is an example generative AI model that generates tokens representing new words, sentences, paragraphs, passages, and/or the like that do not pre-exist in an input of tokens to such LLM. For example, when an LLM generate a text answer to an input question, the text answer contains words and/or sentences that are literally different from those in the input question, and/or carry different semantic meaning from the input question.

In one embodiment, the term “AI agent” may refer to a set of software and/or hardware that processes information from its environment and takes action to achieve specific goals such as executing a task. For example, an AI agent (like a chatbot or virtual assistant) might use an LLM as a component but also integrate tools like web browsing, APIs, databases, and other forms of reasoning to complete tasks.

### Overview

Retrieval augmented generation (RAG) LLM may comprise a retrieval component that searches a large database of documents to find the most relevant pieces of information based on an input query and a generative LLM that contextually relevant text based on the input query and the retrieved information. For example, the retrieval component may comprise a search engine or a specialized retrieval model. The retrieved documents or snippets may serve as a source of information for the generative LLM. In this way, by grounding the generation in real-world documents, RAG LLMs can produce more factually accurate and relevant responses. Also, as the retrieval component can access up-to-date information, RAG LLMs are often able to generate texts on topics that evolve over time, without constant re-training or finetuning.

For example, RAG LLM may search for and retrieve context information from a knowledge graph having nodes representing entities and edges representing relationships between such entities in response to an input query. Some systems (such as co-pending and commonly-owned U.S. nonprovisional application Ser. No. 19/006,731, which is hereby expressly incorporated by reference herein in its entirety) may synthesize an enhanced knowledge graph using an LLM to extract entities, propositions (basic facts associated with an entity) and relationships (between entities) and then using such triplets to synthesize the knowledge graph. Thus, in response to an input query, the knowledge graph of triplets is traversed based on the query to (i) retrieve a subgraph of relevant propositions, and (ii) further filtered by relevant query entities, (iii) the remaining propositions are combined as the final context for answer generation.

In view of the need for a RAG system for generating answers with improved accuracy, relevance, contextual awareness, and efficiency, embodiments described herein provide a dual-layer knowledge graph based on which a dual-retrieval pipeline retrieved a context for response generation.

In one embodiment, the dual-layer knowledge graph is generated combining (i) a first knowledge graph generated using a similar method in U.S. nonprovisional application Ser. No. 19/006,731, and (ii) a second knowledge graph is created by an LLM, based on the original document, the (proposition, entity) tuples already extracted in (i) and an ontology sample (retrieved based on the type of document, or sample queries), to extract ontology-based triplets. For the first knowledge graph, a node embedding is generated for encoding key-value pairs in node properties; and a proposition embedding is generated for each proposition, and a mapping relationship is created between node embeddings and the proposition embeddings. In this way, given an input query, the LLM may traverse both knowledge graphs and adopt a combination, or an intersection of retrieved information as a context for RAG.

In one embodiment, the dual-retrieval pipeline is provided as follows. Given a knowledge graph (can be any suitable knowledge graph and doesn't have to be the disclosed dual-layer knowledge graph) and an input query, (i) an LLM translates the user query into a structured query language based graph query to retrieve a subgraph from the knowledge graph; and (ii) the LLM retrieves relevant propositions and entities based on embedding similarity between the user query and proposition/entity embeddings indexed in the knowledge graph(s), followed by K-hop traversal to achieve the final context for RAG.

Embodiments described herein provide a number of benefits. For example, with context aggregated from retrieval from different knowledge graphs and different retrieval constraints (e.g., “interleaved” dual-layer or dual-retrieval to filter retrieved information), RAG may be performed with reduced but relevant tokens as context information, the retrieval and the answer generation based on the retrieval may have improved accuracy and can be performed with improved efficiency. Therefore, with improved performance on AI-assisted chatbots based on RAG, neural network technology in various technical fields that employ AI-assisted chatbots such as healthcare, network issue support, travel, business discovery and review, can be improved.

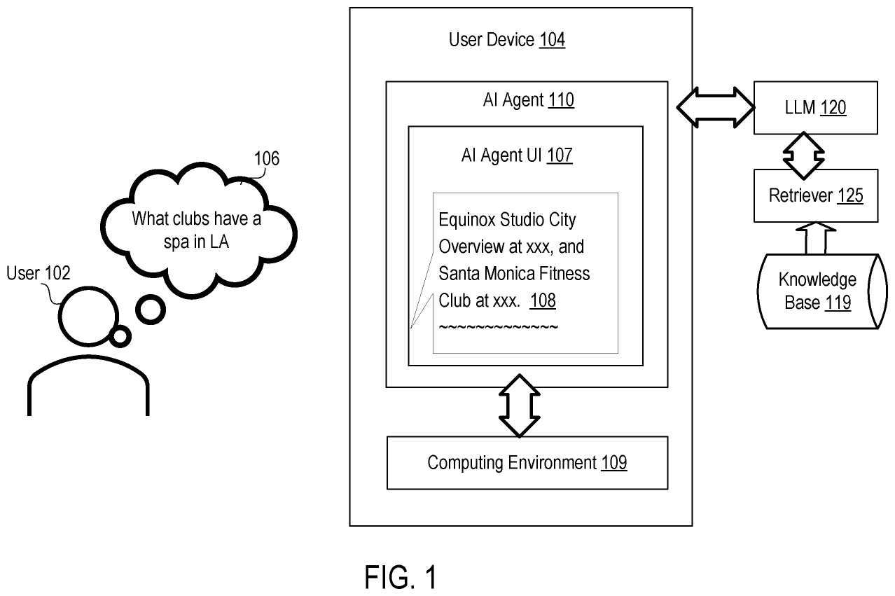

FIG. 1 illustrates an example operation of an LLM based AI agent, according to embodiments of the present disclosure. An LLM-based AI agent 110 may be implemented on a user device 104 to receive a user task request 106 as a natural language input, typically through a chat or command interface 107. This request 106 may range from simple queries to more complex tasks like data analysis, automation, or even generating content. For example, the user 102 may ask the AI agent to “What clubs have a spa in LA” 106.

In one embodiment, the AI agent 110 may process the task request 106 at an LLM 120 to understand its intent, extracting key information such as the task type, desired outcome, and any specific constraints in order to generate a response. The LLM 120 may be hosted at an external server, a cloud service, and/or the like that is accessible by a communication network. In a different implementation, the LLM 120 may be hosted on the user device 104. An input to the LLM 120 may comprise the task request 106 and instruction provided to the LLM 120 to guide its behavior or responses in a particular way, referred to as a “system prompt.” For example, the system prompt may contain instruction for the LLM 120 to analyze the input and respond according to the request identified in the input, and generate an output in a certain format, e.g., suggested code program, text description, etc. The LLM 120 may in turn generate a response 108 based on an input combining the task request 106 and any system prompt. The LLM 120 may operate with a retriever model 125, which retrieves relevant context documents from a knowledge base 119 as a context, to in turn generate a textual response 108 based on an input combining the task request 106, any system prompt and the retrieved context.

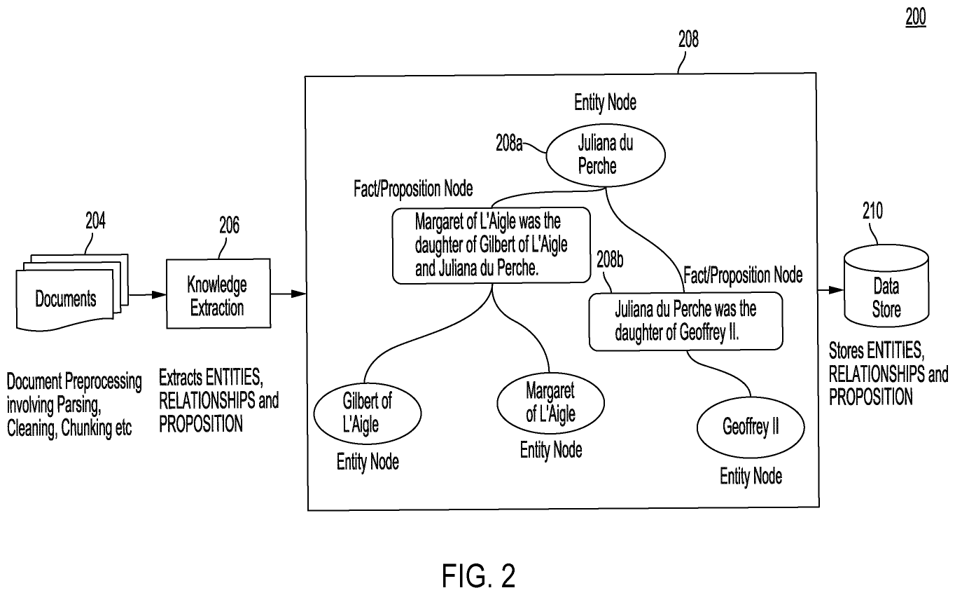

In one embodiment, the knowledge base 119 may comprise a dual-layer knowledge graph constructed from a corpus of documents and/or other form of contexts, as described as element 208 in FIG. 2. The retriever 125 may thus perform a dual-retrieval process on the dual-layer knowledge graph to retrieve relevant context for generation, as described in FIGS. 2, 4, 5, 6A, and 6B.

Additional details on the operation of a dual-layer knowledge graph based retrieval and generation process to form the response 108 may be further described in FIGS. 2-6.

The response 108 may include instructions, explanations, code scripts or direct actions to address the task request 106. Such response 108 may be displayed via the AI agent interface 107 for transparency. In addition to the response 108 that describes how to fulfill the task request, the LLM 120 may generate computer-executable commands (e.g., system-level commands, Python scripts, etc.) that can directly trigger actions and/or interactions with the computing environment 109 on the user device 104.

For example, when the user 102 requests to locate a club with a spa in LA, the LLM 120 may output a code script to execute on the computing environment 109 (such as a travel application and/or business discovery and review application) on the user device 104 to select the most relevant entities and contextual information, and/or interface with APIs of other applications to identify the spa and/or the like.

In this way, the LLM-based AI agent 110 may facilitate end-to-end workflow to automate the task request 106.

FIG. 2 shows a pipeline 200 of knowledge graph construction by the dual-layer knowledge graph framework. The knowledge graph construction may be a process by which the dual-Layer knowledge graph framework transforms heterogeneous source documents into a structured, queryable hybrid knowledge graph. The pipeline 200 may integrate structured data (entities and relationships) with unstructured semantic propositions and document-level content, creating a unified knowledge representation that supports both precise retrieval and contextual understanding.

In one embodiment, pipeline 200 may receive a set of input documents 204, which may be in formats supported by pipeline 200 (e.g., hyper text markup language (HTML), portable document format (PDF), etc.). Input document 204 may include structured or unstructured data sources, and may include any suitable publicly available data and/or proprietary data. For example, input documents 204 may include enterprise databases, customer records, technical specifications, etc., and may include text, tables, images, metadata, and/or multimodal data. Pipeline 200 may process the input documents 204 by parsing, cleaning, and chunking, to generate one or more parsed documents with a clean and formatted content. For example, excessive or unsuitable contents from input documents 204 have been removed, and/or a large piece of text may be segmented into smaller manageable sections/chunks, to generate the processed documents. The processed documents may be in formats suitable for a subsequent extraction process. For example, the pipeline 200 may process a HTML document such as anthemrow.html. (from the input documents 204) to generate a corresponding text document anthemrwo.txt.

In one embodiment, pipeline 200 may preform knowledge extraction 206 on the preprocessed documents 204, such as extracting entities, relationships, and propositions from the processed documents, for constructing one or more knowledge graphs. Each document or document chunk may be processed to extract entities (objects with types and attributes), relationships (connections between entities), and propositions (factual statements linking entities).

In some embodiments, pipeline 200 may extract the entities, relationships, and propositions from documents 204 without a pre-defined ontology. For example, the pipeline 200 may adopt a language model with a system prompt to generate triplets ofentities, relationships, and propositions from an input document.

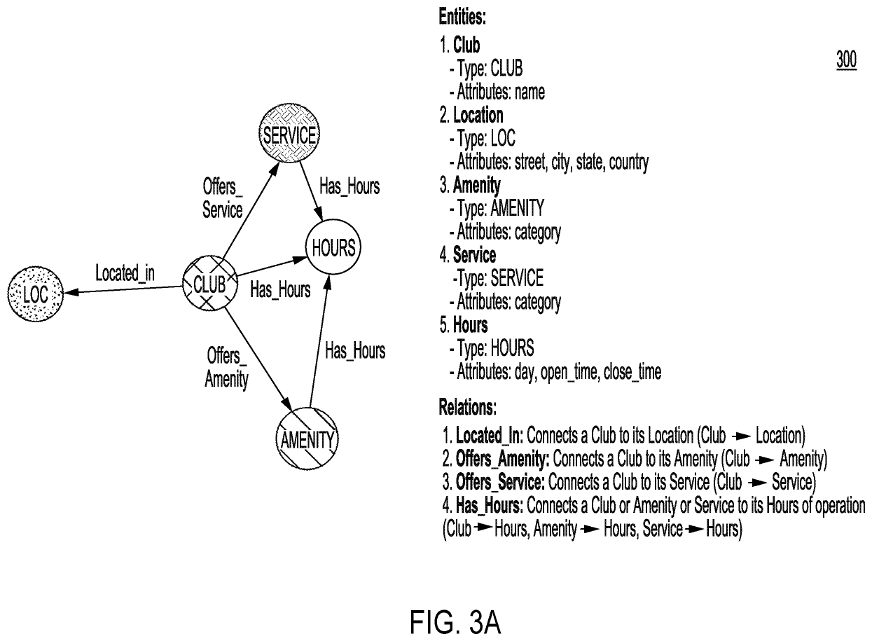

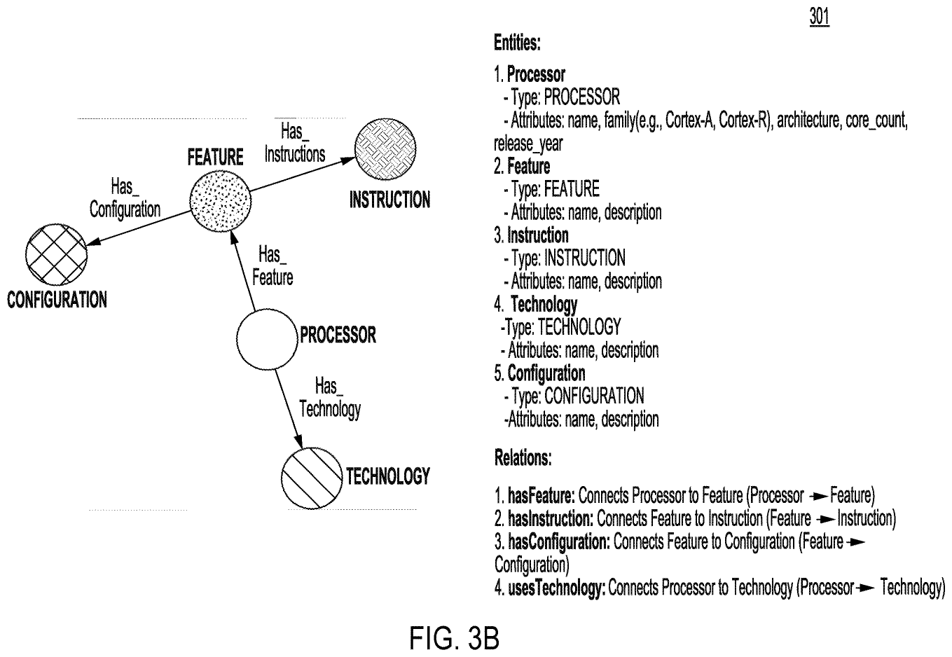

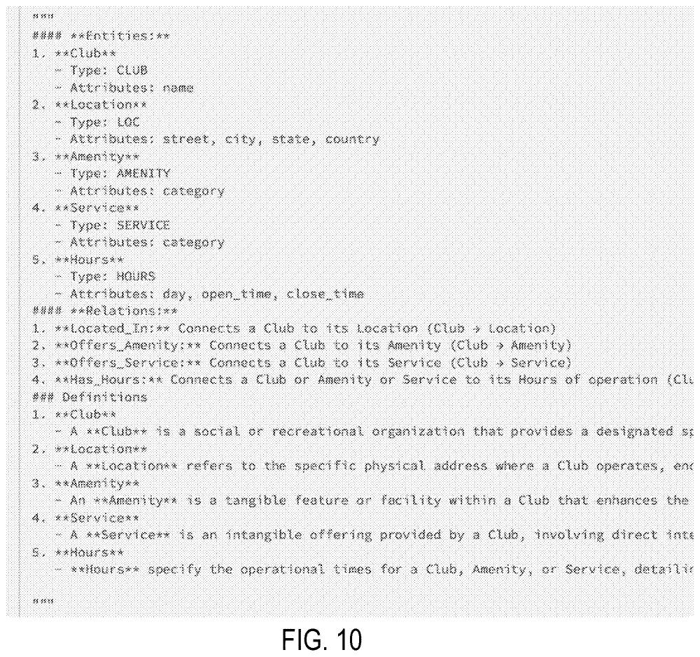

In some embodiments, pipeline 200 receives a sampled ontology prior to the extraction, and may extract entities, propositions, and relationships guided by the sampled ontology as a blueprint. For example, the sampled ontology may be tailored to the user question (e.g., query) to be received by the dual-layer knowledge graph framework, and may provide definitions and examples for what entities, relationships, and/or propositions should be extracted. For example, FIG. 10 shows an example of a prompt instruction to sample an ontology. Details of the ontology may be described in FIGS. 3A and 3B.

In one embodiment, the pipeline 200 may process the extracted entities, relationships, and propositions to generate resolved entities, relationships, and propositions. Pipeline 200 may perform entity resolution on the extracted entities, relationships, and propositions to consolidate duplicate or related entities, their corresponding relationships, and their corresponding propositions. This operation may help improve consistency and reducing redundancy in the to-be-generated knowledge graph.

In one embodiment, the pipeline 200 may create an index for each node type in a knowledge graph. The pipeline 200 may determine entity nodes 208a and proposition (“fact”) nodes 208b in a knowledge graph 208. Entity nodes 208a may be connected or linked by a proposition node 208b. The pipeline 200 may index the entities and their corresponding propositions. Specifically, pipeline 200 may compute a node (e.g., entity, proposition) embedding by encoding key-value pairs of the corresponding node in the node properties. Pipeline 200 may also include entity IDs in the corresponding node (e.g., entity, and/or proposition) embeddings. In an example, each key and its properties may be retrieved and turned into a string such as key: properties, and the string may be added to a list of properties_text using properties_text.append(“{}:{}”. Format(key, properties[key])). The node embedding of each node may be computed as node_embedding=get_embedding(“\n”.join(properties_text)). For example, an entity embedding and a proposition embedding may each include the ID of the corresponding entity. In one embodiment may enable efficient similarity-based retrieval of entities.

In one embodiment, the pipeline 200 may index proposition embeddings. An index may be created for each extracted proposition embedding. Meanwhile, the pipeline 200 may maintain a mapping between propositions and the corresponding document chunks from which they were extracted, enabling traceability from facts back to the input documents 304.

In some embodiments, the pipeline 200 constructs a first knowledge graph having extracted entities, propositions, and relationships, similar to that disclosed in U.S. nonprovisional application Ser. No. 19/006,731. Node embeddings may be generated for both entity nodes and proposition nodes. Proposition embeddings may be indexed to link a proposition embedding to a corresponding entity.

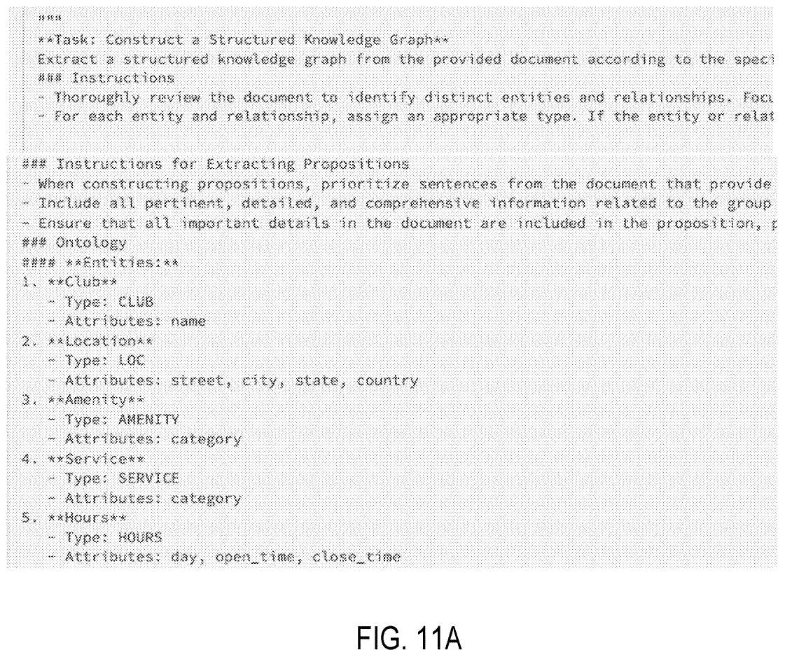

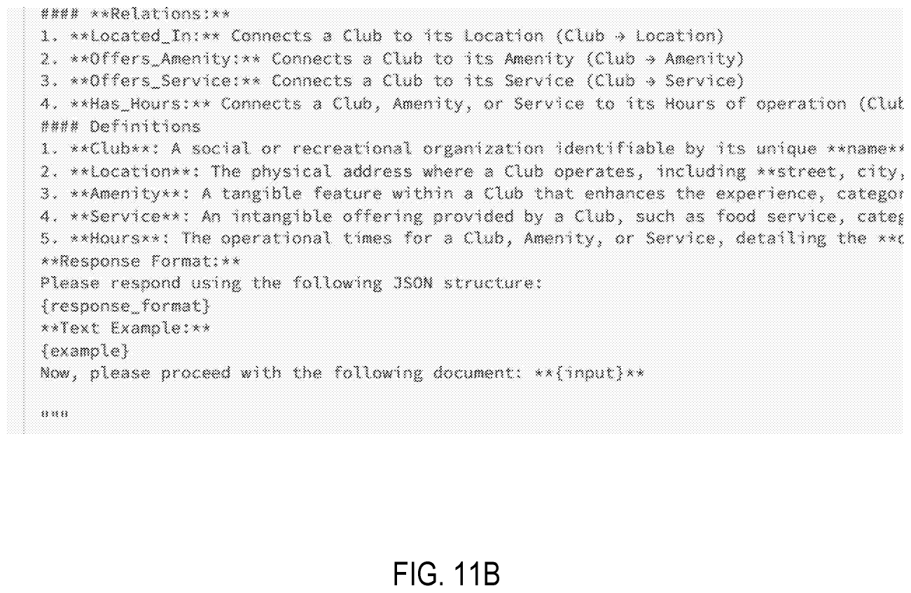

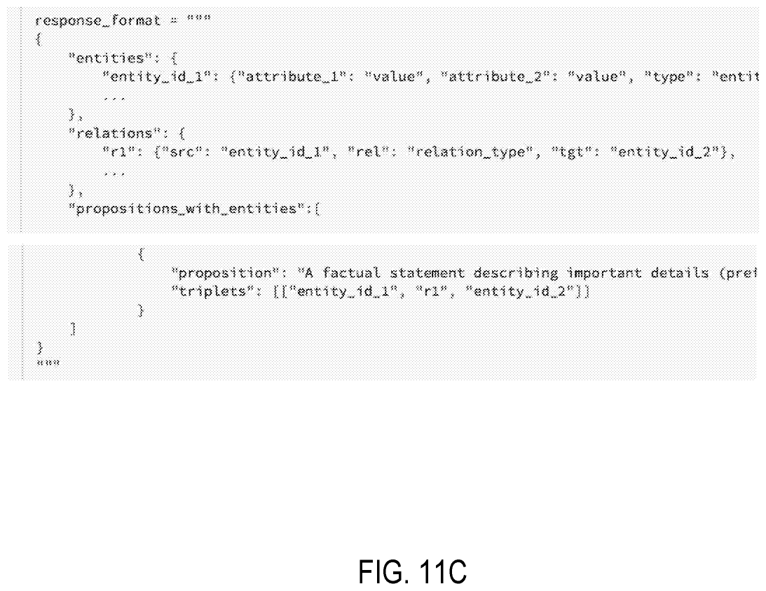

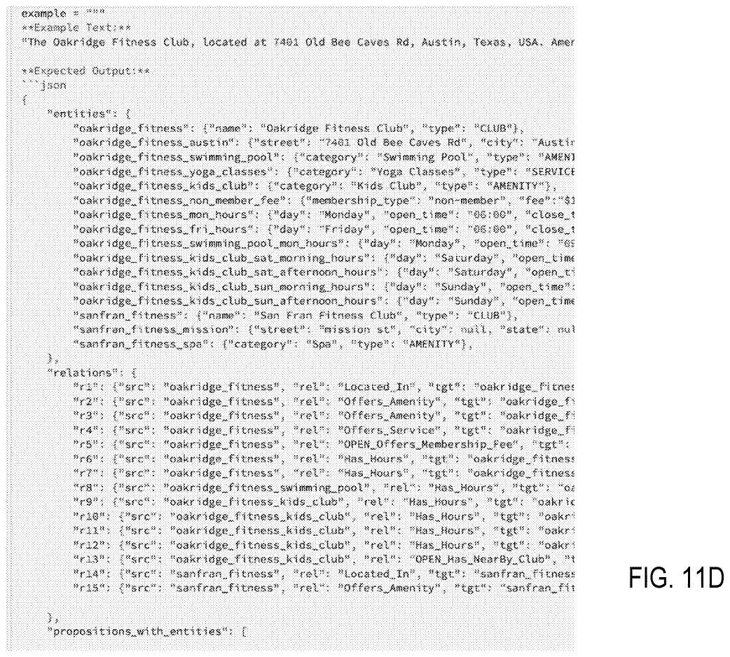

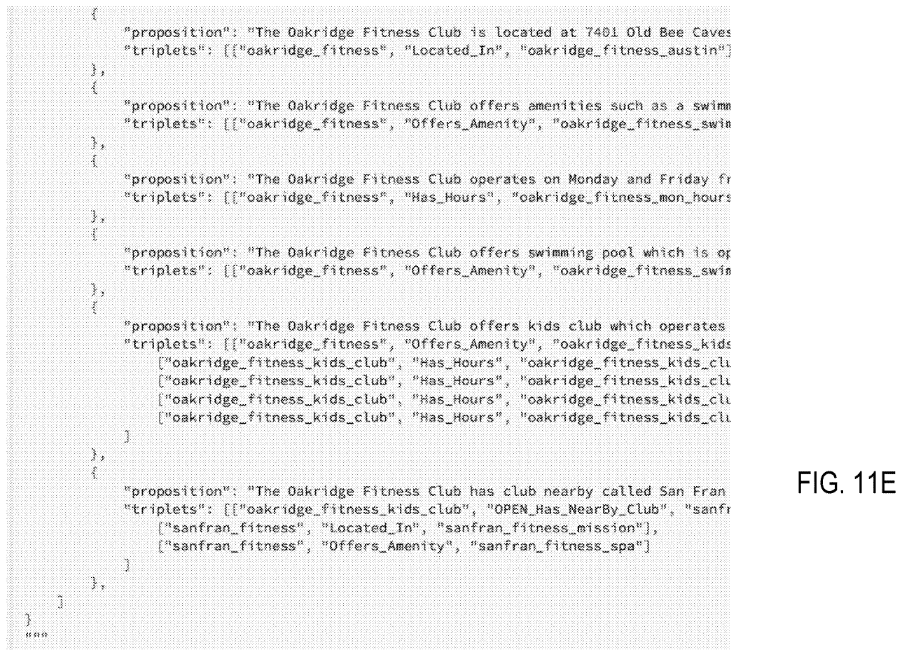

In some embodiments, alternatively or additionally, the pipeline 200 constructs a second knowledge graph guided by a sampled ontology (further described in FIGS. 3A and 3B). For example, the pipeline 200 uses the extracted entities, relationships, and propositions defined by the sampled ontology, to construct the second knowledge graph. In some embodiments, node embeddings are generated for both entity nodes and proposition nodes. Proposition embeddings may be indexed to link a proposition embedding to a corresponding entity. FIGS. 11A-11E show example prompt instructions to extract knowledge graphs. FIG. 11B is a continuation of FIG. 11A, FIG. 11C is a continuation of FIG. 11B, FIG. 11D is a continuation of FIG. 11C, and FIG. 11E is a continuation of FIG. 11D.

In one embodiment, the pipeline 200 may store the knowledge graphs (e.g., first knowledge graph and/or second knowledge graph) in a data store 210. Specifically, the pipeline 200 may store the resolved entities, relationships, and propositions for constructing the first and/or second knowledge graphs in a graph database (DB), and the indexes of the node embeddings (e.g., entity embeddings and/or proposition embeddings) in a vector database (DB). This dual storage approach may enable both structured graph queries and semantic similarity searches.

FIGS. 3A and 3B illustrate examples of sampled ontology used in extracting entities, propositions, and relationships, and generating the second knowledge graph. An ontology may serve as a blueprint for the second knowledge graph, defining the structure and relationships that guide pipeline 200 on how and what information is extracted, organized, and retrieved from the input documents 204.

Pipeline 200 may receive an ontology (e.g., 300 and/or 301) tailored/customized to a sample question that a user wants the knowledge graph to address. The customized ontology may allow the knowledge graph to effectively answer domain-specific queries by capturing the relevant entities, relationships, and contextual information (e.g., from the propositions) needed for accurate retrieval and answer generation.

The ontology may include entities, relationships, definitions, and one or more examples. The entities in the ontology may refer to the core objects or concepts within the domain that the knowledge graph may represent. Each entity may be assigned a type (e.g., “Type” in ontologies 300 and 301). Each entity may have defined attributes (“Attributes” in ontologies 300 and 301) that capture its properties.

The relationships in an ontology may refer to the connections between entities that define how they interact or relate to one another. Each relationship may have a type (e.g., “Located_In” in ontology 300 and “hasFeature” in ontology 301). Relationships may establish the graph structure that enables traversal and multi-hop reasoning.

The definitions in ontology may refer to clear, unambiguous descriptions of each entity, concept, relationship, and property to facilitate consistent interpretation and extraction across documents. Definitions may provide semantic grounding for the knowledge graph.

The examples in ontology may refer to one or more examples or annotations that demonstrate to pipeline 200 how the ontology should be applied (e.g., how the entities, relationships, and propositions should be extracted from the input documents 204). In some embodiments, the examples may be few-shot (e.g., a small number of) examples.

In some embodiments, pipeline 200 may apply references for the ontology. The references may include documentation and sources that inform and validate the ontology structure, ensuring alignment with domain standards and requirements. For example, ontology 300 may be an example of ontology after applied with reference data of “EQUINOX” Studio City Overview, and ontology 301 may by an example of ontology after applied with reference data of “ARM” architecture for central processing units (CPUs).

In some embodiments, during document parsing and extraction, the ontology may guide the identification and classification of entities, the establishment of relationships, and the extraction of propositions. This structured approach may allow the resulting second knowledge graph to more accurately represent the domain and supports effective retrievals for the dual-layer knowledge graph framework.

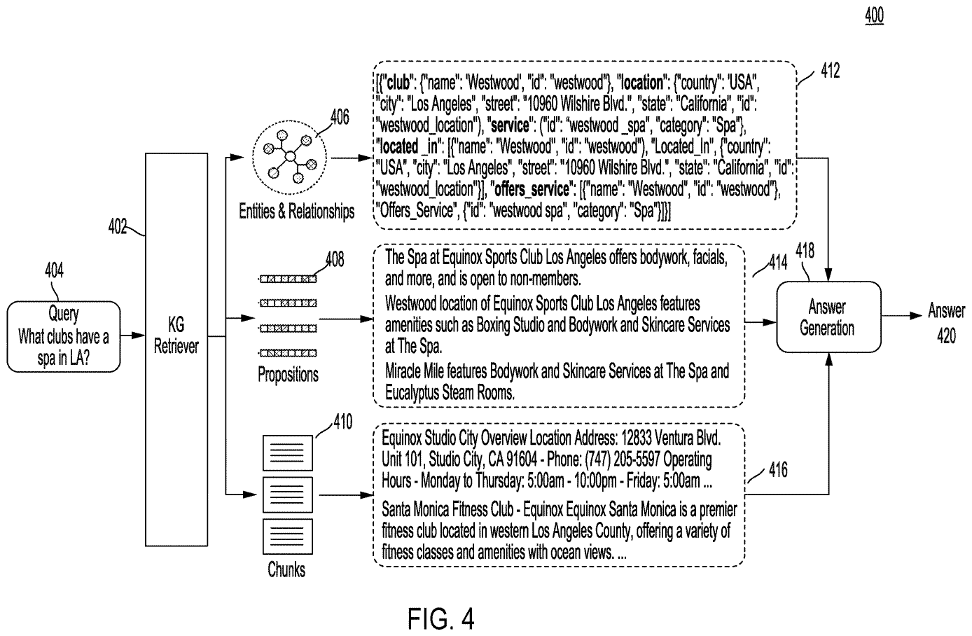

FIG. 4 shows a dual-layer knowledge graph framework 400 generating an answer in response to a user query, according to some embodiments. Dual-layer knowledge graph framework 400 may be an example of AI agent 110, and may be configured to construct knowledge graphs and perform RAG based on the constructed knowledge graphs(as described in FIG. 2).

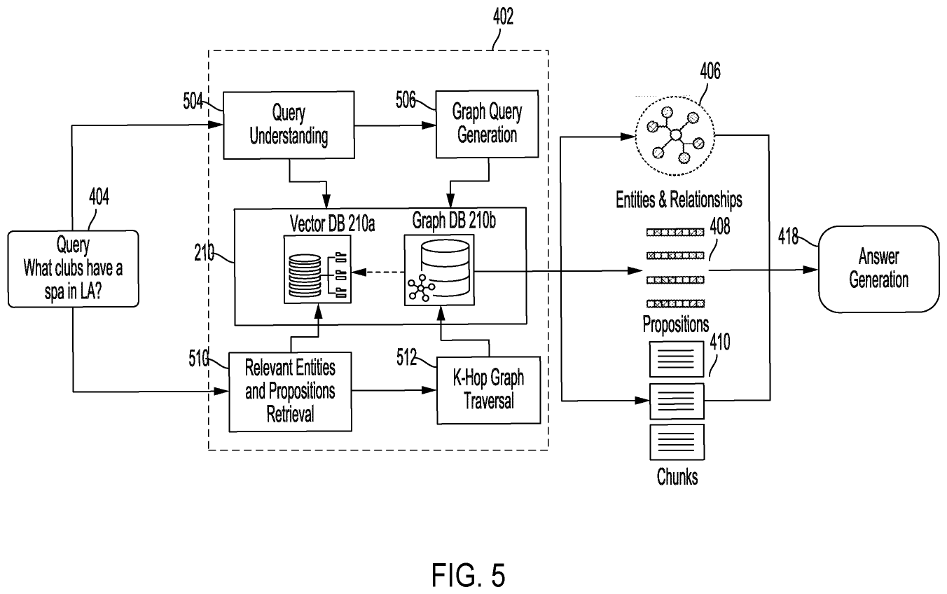

As shown in FIG. 4, the dual-layer knowledge graph framework 400 may receive a query 404 (e.g., a user query/question) asking about “which clubs have a spa in LA”. The KG retriever 402 of the dual-layer knowledge graph framework 400 may generate a subgraph 406 (e.g., example 412), and retrieve propositions 408 (e.g., example 414), and document chunks 410 (e.g., example 416), and perform answer generation 418 based on the subgraph 406, and retrieved proposition 408 and document chunks 410. An answer 420 may be generated as the output. Additional details of the retrieval and generation process may be further provided below in relation to FIG. 5.

FIG. 5 shows the detailed structure of a knowledge graph (KG) retriever in dual-layer knowledge graph framework 400, according to embodiments. As shown in FIG. 5, upon receiving an input prompt that includes query 404, KG retriever 402 may perform query understanding 504, graph query generation 506, relevant entities and propositions retrieval 510, and K-hop graph traversal to generate a subgraph 406, a set of propositions 408, and a set of document chunks 410 based on query 404 and knowledge graphs saved in database 210 (a vector database 210a and a graph database 210b). The dual-layer knowledge graph framework 200 may then perform answer generation 418 to output an answer 420 based on query 404, and subgraph 406, the set of propositions 408, and the set of document chunks 410.

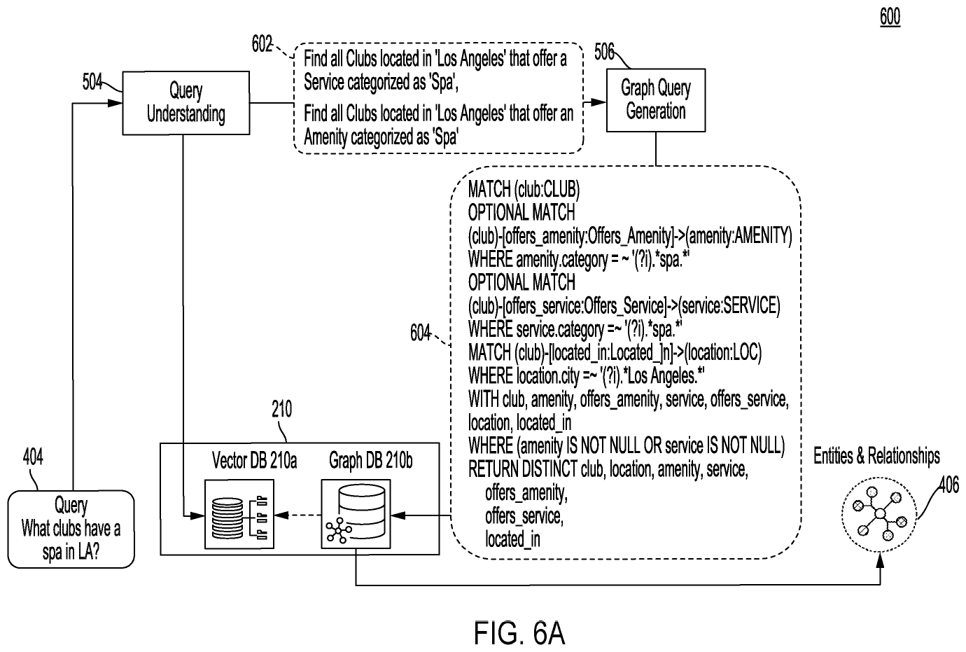

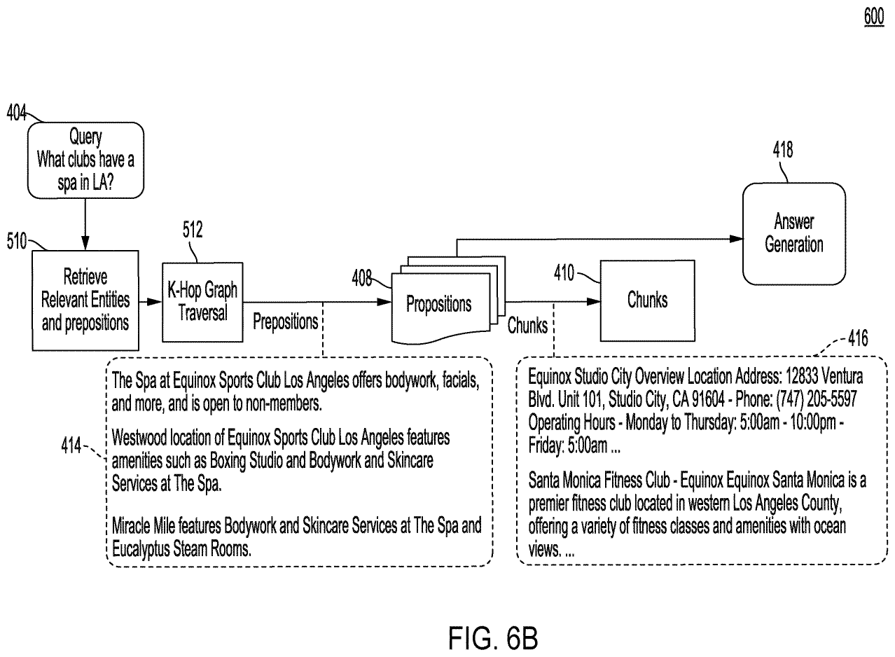

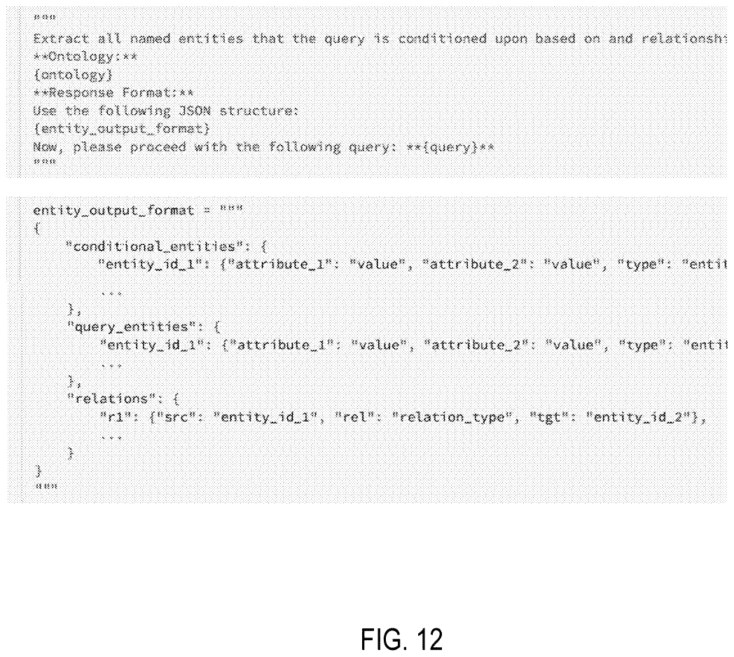

FIGS. 6A and 6B show the two retrievals performed by the KG retrieval, according to some embodiments. FIGS. 12-15 show prompt instructions used to perform certain operations in the dual-layer knowledge graph framework 400.

In some embodiments, the KG retriever 402 may perform a first retrieval 600, as shown in FIG. 6A, which converts an input query into a relevant subgraph 406 for answer generation 418. KG retriever 402 may perform first retrieval 600 as described below. FIG. 6A is also referred to as a structured knowledge graph retrieval pipeline.

In one embodiment, upon receiving query 404, KG retriever 402 may generate a query embedding (e.g., representation) corresponding to query 404.

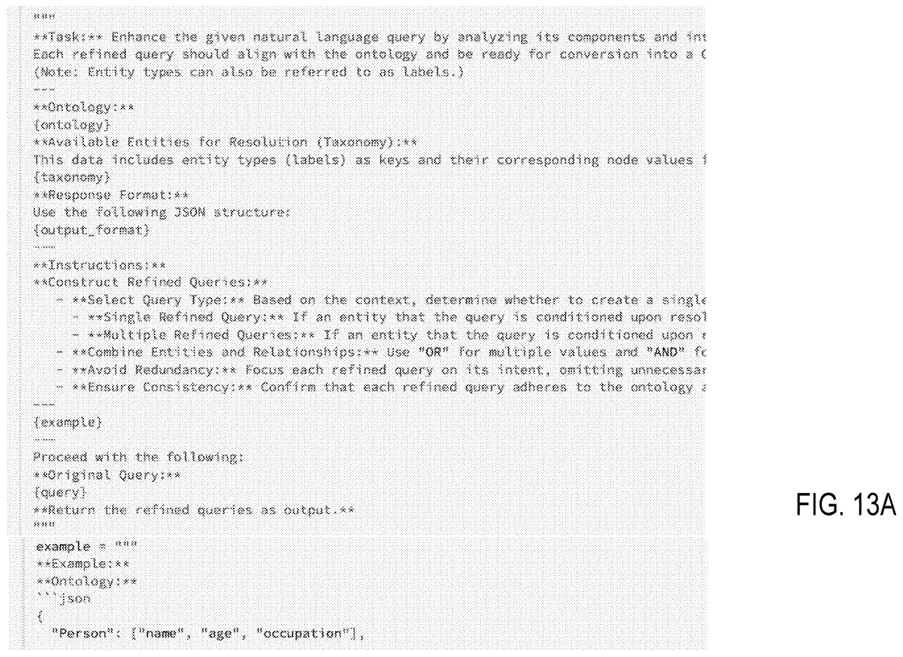

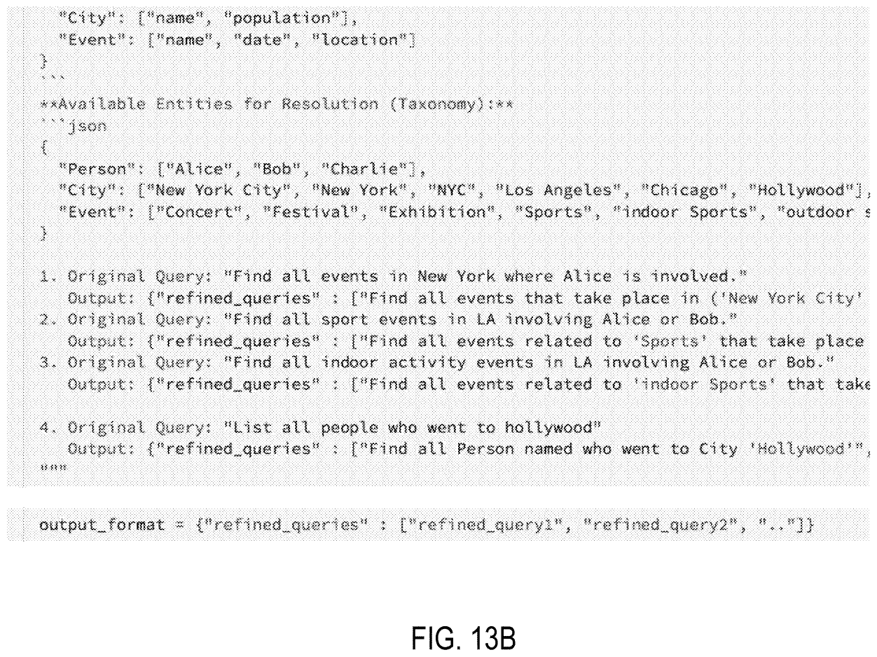

In one embodiment, KG retriever 402 may perform query understanding 504 based on the query embedding. In this operation, KG retriever 402 may receive the query embedding and query 404 as input and output a resolved query 602. In some embodiments, the KG retriever 402 identifies entities and relationships in query 602, and retrieves the top K relevant entity (nodes) from each node type in database 210 (vector database 210a and/or graph database 210b), and identifies entities and relationships in the query to determine intent and perform entity resolution to consolidate duplicated entities to generate resolved query 602. FIG. 12 shows an example of a prompt instruction to detect entities according to a sampled ontology, which may be the same ontology used to construct the second knowledge graph. As previously described, database 210 may be stored with the entities, relationships, and propositions for the first knowledge graph and/or the second knowledge graph (e.g., in graph database 210b), and indices of the node embeddings for the first knowledge graph and/or the second knowledge graph (e.g., in vector database 210a). In some embodiments, the resolved query 602 includes one or more queries with identified unique entities and corresponding relationships. In some embodiments, the KG retriever 402 retrieves the top K relevant entities based on the first knowledge graph and/or the second knowledge graph stored in database 210, as described in FIG. 2. In some embodiments, the entity resolution may clarify ambiguous references and standardize entity mentions according to the ontology. KG retriever 402 may, if needed, rewrite query 404 to facilitate graph query generation 506. FIGS. 13A and 13B (continuation of FIG. 13A) show pseudo code of example prompt instructions to perform query understanding and/or rewriting.

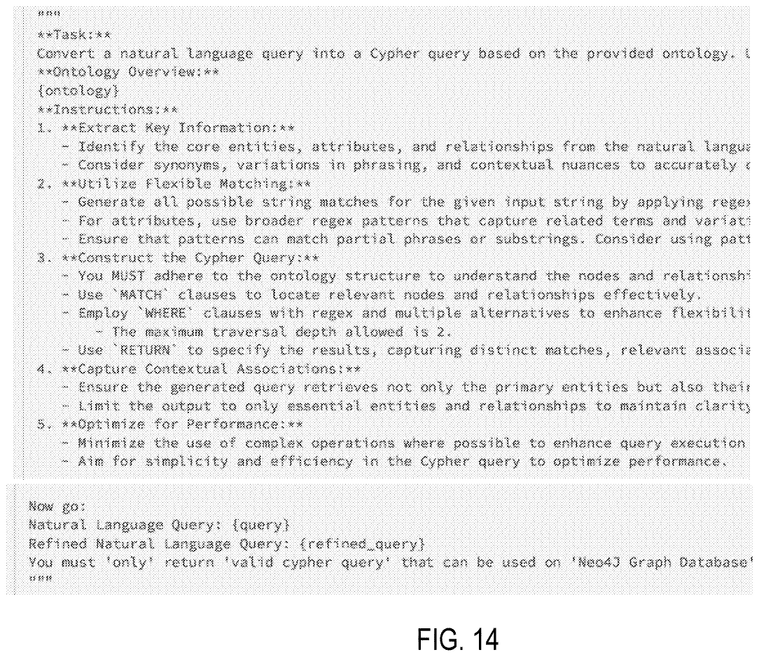

In one embodiment, KG retriever 402 may perform graph query generation 506, which translates the resolved query 602 into a graph query in a structured query language. For example, the KG retriever 402 may receive the resolved query 602 as an input, and generate an intermediate output 604 which includes Cypher queries for extracting data from the database 210. The Cypher queries include query expression configured to operate on graph-base structure and may include a sequence of clauses including, but not limited to pattern-matching clauses, filtering clauses, projection clauses, update clauses, etc. For example, as further shown in FIG. 14, the Cypher queries may use MATCH clauses to locate relevant nodes and relationships, WHERE clauses with regex for flexibility, and RETURN to specify results.

The KG retriever 402 may query the first knowledge graph and the second knowledge graph stored in vector database 210a and graph database 210b using intermediate output 604 to extract a relevant subgraph 406 that contains the entities, relationships, and the propositions in the intermediate output 604. The subgraph 406 may be part of the first knowledge graph, part of the second knowledge graph, or a combination of both. The subgraph 406 may include one or more entities (e.g., nodes) from the first knowledge graph and/or the second knowledge graph, one or more propositions (e.g., nodes) from the first knowledge graph and/or the second knowledge graph, and may preserve the connectivity among included nodes according to the relationships present in the first knowledge graph and/or second knowledge graph. In some embodiments, the knowledge graph used to generate subgraph 406 may also be any other suitable knowledge graphs stored in database 210. For example, subgraph 406 may include a neighborhood of a node (e.g., entity, proposition) with a specified traversal depth, and/or a domain-specific partition of the first knowledge graph and/or second knowledge graph. In some embodiments, subgraph 406 contain the structured nodes, propositions, and relationships that are most relevant to query 404.

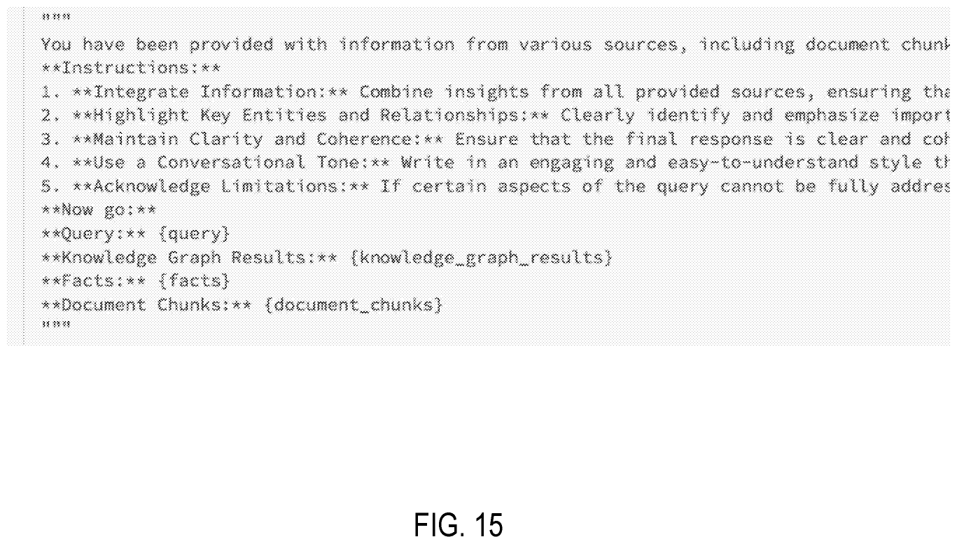

In some embodiments, dual-layer knowledge graph framework 400 may generate answer 420 based on a combination of query 404 and subgraph 406. That is, dual-layer knowledge graph framework 400 may generate answer 420 without performing the second retrieval described in FIG. 6B. For example, the propositions included in subgraph 406 may be used as the context information for the entities mentioned in the query 404. FIG. 15 shows an example of prompt instruction for answer generation 418.

The first retrieval 600 may produce a subgraphs with nodes and relationships that are most relevant to the query 404, providing precise, bounded results that can be used alone or combined with the output of the second retrieval 601 for answer generation 418.

In some embodiments, the KG retriever 402 may perform a second retrieval 601, as shown in FIG. 6B, which retrieves propositions 408 and document chunks 410 that can be used as context information for answer generation 418. KG retriever 402 may perform second retrieval 601 in the operations below. FIG. 6B may also be referred to as an embedding similarity based graph retrieval pipeline.

In one embodiment, the KG retriever 402 may extract all relevant entities from query 404. In various embodiments, this operation may be performed with or without a sampled ontology. In some embodiments, the KG retriever 402 generates a query embedding corresponding to query 404. In some embodiments, the KG retriever 402 also generates entity embeddings for all the extracted entities. FIG. 12 shows an example of prompt instruction to extract entities according to a sampled ontology.

In one embodiment, the KG retriever 402 may retrieve relevant entities and propositions 510 to the entities extracted from query 404. Using embedding similarity between query 404 and the node embeddings (e.g., entity embeddings and proposition embeddings) stored in database 210, the KG retriever 402 may perform two parallel retrievals: (a) retrieving the top M relevant propositions to the query 404 based on semantic similarity between the query embedding and proposition embeddings indexed and stored in database 210, and (b) retrieving the top N relevant entities to the query 404 based on semantic similarity between entity embeddings of the extracted entities and entity embeddings indexed and stored in database 210. The KG retriever 402 may then generate a subgraph that includes the retrieved top-M propositions and all entities linked to the top-M propositions in the first knowledge graph and/or second knowledge graph stored in database 210.

In one embodiment, the KG retriever 402 may perform a K-hop graph traversal 512. The KG retriever 402 may use the top-N entities retrieved as starting points, perform a K-hop traversal within the subgraph created. During traversal, the KG retriever may collect all propositions that are reachable within K hops from any of the top-N entities. This operation may expand the coverage for contextual information.

Optionally, the KG retriever 402 may perform proposition filtering. The KG retriever 402 may select a subset of the collected propositions 408 for subsequent processing based on relevance between the query 404 and the collected propositions. In some embodiments, the KG retriever 402 calculates the relevance score between the query 404 and each of the collected propositions, and selects the propositions with relevance scores higher than a predetermined threshold to form the subset of the collected propositions 408. The relevance scores may be calculated based on keyword matching, semantic similarity, and/or the like. In some embodiments, the KG retriever 402 calls an LLM to perform the proposition filtering.

In one embodiment, the KG retriever 402 may perform chunk selection to retrieve a set of document chunks 410 from the input documents (e.g., 204). The set of document chunks 410 may correspond to the subset of collected propositions 408 (or all the collected propositions if proposition filtering is not performed).

In some embodiments, the KG retriever 402 may receive the query embedding of query 404 as an input, and may output the subset of the collected propositions 408 (e.g., example 414 in FIG. 4) and the set of chunks 410 (e.g., example 416 in FIG. 4). In other words, the subset of the collected propositions 410 and the set of chunks 410 include semantically relevant propositions (factual statements) along with the corresponding source document chunks from which they were extracted.

Second retrieval 601 may employ a dual embedding similarity approach that operates on two levels: (i) query-to-proposition similarity. The query embedding may be compared against proposition embeddings to identify the top M propositions that are semantically most similar to the query, while the propositions capture factual statements from source documents, providing rich contextual information. (ii) query-to-entity similarity. The query embedding may also be compared against entity embeddings to identify the top N entities that are semantically most relevant. The N entities may serve as anchor points for the K-hop traversal.

In some embodiments, dual-layer knowledge graph framework 400 may generate answer 420 based on a combination of query 404, subgraph 406, the subset of the collected propositions 410, and the set of chunks 410. That said, the dual-layer knowledge graph framework 400 may perform both the first retrieval 600 and the second retrieval 601 for the answer generation 418. For example, the propositions included in subgraph 406, the subset of the collected propositions 410, and the set of chunks 410 may be used as the context information for the entities mentioned in the query 404.

Together, first retrieval 600 and second retrieval 601 may form a dual-retrieval approach that combines structured graph querying with embedding similarity retrieval. While first retrieval 600 may provide precise, relationship-aware subgraphs through structured queries, second retrieval 601 may capture semantic meaning and contextual associations through embedding similarity and K-hop traversal. The combined results are layered into three granular levels—structured nodes and relationships, mid-level propositions, and high-level document chunks—to provide a coherent, context-rich input for answer generation in RAG systems.

### Computer and Network Environment

FIG. 7A is a simplified diagram illustrating a computing device implementing the dual-layer knowledge graph framework 400 described in FIGS. 1-6B, according to one embodiment described herein. As shown in FIG. 7A, computing device 700 includes a processor 710 coupled to memory 720. Operation of computing device 700 is controlled by processor 710. And although computing device 700 is shown with only one processor 710, it is understood that processor 710 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 700. Computing device 700 may be implemented as a stand-alone subsystem, as a board added to a computing device, and/or as a virtual machine.

Memory 720 may be used to store software executed by computing device 700 and/or one or more data structures used during operation of computing device 700. Memory 720 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 710 and/or memory 720 may be arranged in any suitable physical arrangement. In some embodiments, processor 710 and/or memory 720 may be implemented on a same board, in a same package (e.g., system-in-package), on a same chip (e.g., system-on-chip), and/or the like. In some embodiments, processor 710 and/or memory 720 may include distributed, virtualized, and/or containerized computing resources. Consistent with such embodiments, processor 710 and/or memory 720 may be located in one or more data centers and/or cloud computing facilities.

In another embodiment, processor 710 may comprise multiple microprocessors and/or memory 720 may comprise multiple registers and/or other memory elements such that processor 710 and/or memory 720 may be arranged in the form of a hardware-based neural network, as further described in FIG. 7B.

In some examples, memory 720 may include non-transitory, tangible, machine readable media that includes executable code that when run by one or more processors (e.g., processor 710) may cause the one or more processors to perform the methods described in further detail herein. For example, as shown, memory 720 includes instructions for dual-layer knowledge graph module 730 that may be used to implement and/or emulate the systems and models, and/or to implement any of the methods described further herein. dual-layer knowledge graph module 730 may receive input 740 such as an input training data (e.g., sets of (user query, groundtruth answer, sampled ontology, source documents)) via the data interface 715 and generate an output 750 which may be predicted answers.

The data interface 715 may comprise a communication interface, a user interface (such as a voice input interface, a graphical user interface, and/or the like). For example, the computing device 700 may receive the input 740 (such as a training dataset) from a networked database via a communication interface. Or the computing device 700 may receive the input 740, such as sets of (user query, groundtruth answer, sampled ontology, source documents), from a user via the user interface.

In some embodiments, the dual-layer knowledge graph module 730 is configured to generate an answer given a user query. The dual-layer knowledge graph module 730 may further include a knowledge submodule 731 (e.g., similar to pipeline 200 in FIG. 2), a retriever submodule (e.g., similar to KG retriever 402 in FIGS. 4 and 5), an answer generation submodule 733 (e.g., similar to answer generation 418 in FIGS. 4 and 5), a LLM submodule 734, and a visualization submodule 735. Knowledge graph submodule 731 may be configured to generate and store a first knowledge graph and/or a second knowledge graph in receiving a set of input documents, as described in FIG. 2. In some embodiments, the knowledge graph submodule 731 is configured to sample an ontology based on a user query. Retriever submodule 732 may be configured to perform a first retrieval and/or a second retrieval in receiving a user query, as described in FIGS. 4, 5, 6A, and 6B. Retriever submodule 732 may output a subgraph (e.g., 406), a set of propositions (e.g., 408) most relevant to the user query, and/or a set of document chunks (e.g., 410) most relevant to the user query. Answer generation submodule 733 may be configured to generate an answer (e.g., 420) relevant to the entities in the user query, using the context information from the set of propositions and the set of document chunks generated by the retriever submodule 732. LLM submodule 734 may be configured to call one or more LLMs to perform the operations by submodules 731-733. Visualization submodule 735 may be configured to display a generated answer (e.g., 420), and/or any data generated prior to generating the answer, on a user device (e.g., 104).

Some examples of computing devices, such as computing device 700 may include non-transitory, tangible, machine readable media that include executable code that when run by one or more processors (e.g., processor 710) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

FIG. 7B is a simplified diagram illustrating the neural network structure implementing the dual-layer knowledge graph module 730 described in FIG. 7A, according to some embodiments. In some embodiments, the dual-layer knowledge graph module 730 and/or one or more of its submodules 731-735 may be implemented at least partially via an artificial neural network structure shown in FIG. 7B. The neural network comprises a computing system that is built on a collection of connected units or nodes, referred to as neurons (e.g., 744, 745, 746). Neurons are often connected by edges, and an adjustable weight (e.g., 751, 752) is often associated with the edge. The neurons are often aggregated into layers such that different layers may perform different transformations on the respective input and output transformed input data onto the next layer.

For example, the neural network architecture may comprise an input layer 741, one or more hidden layers 742 and an output layer 743. Each layer may comprise a plurality of neurons, and neurons between layers are interconnected according to a specific topology of the neural network topology. The input layer 741 receives the input data (e.g., 740 in FIG. 7A), such as sets of (user query, groundtruth answer, sampled ontology, source documents). The number of nodes (neurons) in the input layer 741 may be determined by the dimensionality of the input data (e.g., the length of a vector of sets of (user query, groundtruth answer, sampled ontology, source documents)). Each node in the input layer represents a feature or attribute of the input.

The hidden layers 742 are intermediate layers between the input and output layers of a neural network. It is noted that two hidden layers 742 are shown in FIG. 7B for illustrative purpose only, and any number of hidden layers may be utilized in a neural network structure. Hidden layers 742 may extract and transform the input data through a series of weighted computations and activation functions.

For example, as discussed in FIG. 7A, the dual-layer knowledge graph module 730 receives an input 740 of sets of (user query, groundtruth answer, sampled ontology, source documents) and transforms the input into an output 750 of a generated answer. To perform the transformation, each neuron receives input signals, performs a weighted sum of the inputs according to weights assigned to each connection (e.g., 751, 752), and then applies an activation function (e.g., 761, 762, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 741 is transformed into rather different values indicative data characteristics corresponding to a task that the neural network structure has been designed to perform.

The output layer 743 is the final layer of the neural network structure. It produces the network's output or prediction based on the computations performed in the preceding layers (e.g., 741, 742). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the dual-layer knowledge graph module 730 and/or one or more of its submodules 731-735 may comprise the transformative neural network structure of layers of neurons, and weights and activation functions describing the non-linear transformation at each neuron. Such a neural network structure is often implemented on one or more hardware processors 710, such as a graphics processing unit (GPU). An example neural network may be GPT-4o, GPT-5, and/or the like.

In one embodiment, the dual-layer knowledge graph module 730 and its submodules 731-735 may comprise one or more LLMs built upon a Transformer architecture. For example, the Transformer architecture comprises multiple layers, each consisting of self-attention and feedforward neural networks. The self-attention layer transforms a set of input tokens (such as words) into different weights assigned to each token, capturing dependencies and relationships among tokens. The feedforward layers then transform the input tokens, based on the attention weights, represents a high-dimensional embedding of the tokens, capturing various linguistic features and relationships among the tokens. The self-attention and feed-forward operations are iteratively performed through multiple layers of self-attention and feedforward layers, thereby generating an output based on the context of the input tokens. One forward pass for an input tokens to be processed through the multiple layers to generate an output in a Transformer architecture often entail hundreds of teraflops (trillions of floating-point operations) of computation.

For example, the Transformer-based architecture may process an input sequence of tokens (e.g., letters, symbols, numbers, signs, words, etc.) using its encoder-decoder architecture (for tasks such as machine translation, etc.) or just the encoder (for classification tasks) or decoder (for generation-only tasks). First, the input sequence may be tokenized and converted into embeddings, which are dense numerical representations, e.g., vectors of values. Positional encodings are added to these embeddings to provide information about the order of tokens.

The Transformer encoder, usually consisting of multiple layers, each of which may process the input using a multi-head self-attention mechanism to capture relationships between tokens and a feed-forward network to transform the information, resulting in encoded representations of the input sequence of tokens.

For example, the multi-head self-attention mechanism at each Transformer layer within the Transformer encoder of an LLM may project input embeddings at the layer into three different embedding spaces using weight matrices, referred to as Query (Q) representing what a token wants to attend to, Key (K) representing what this token offers as information and Value (V) representing the actual information carried by the token. The Q, K, V matrices contain tunable weights of a Transformer-based language model that are updated during training. Then, the attention mechanism computes attention scores between all tokens in the input sequence using the Q, K and V matrices. The resulting attention scores are then used to generate encoded representations of the input sequence of tokens.

Similarly, the Transformer decoder may comprise a symmetric structure with the encoder, consisting of multiple layers, each of which may comprise a multi-head self-attention mechanism. The decoder may start with a special start token and use the multi-head self-attention mechanism, augmented with encoder-decoder attention to focus on relevant parts of the decoder input. The decoder may generate output tokens one by one, with each operation using the previously generated tokens as part of the input and updated attention weights. Finally, the decoder may comprise a linear layer and softmax function predict probabilities for the next token in the sequence, selecting the most likely one to continue the output. This process repeats until a special end token is generated or a length limit is reached.

The generated sequence of tokens may jointly represent an output. For example, a Transformer-based LLM (such as LLM 110a-d) may receive a natural language input (such as a question) and generate a natural language output (such as an answer to the question).

In one embodiment, the dual-layer knowledge graph module 730 and its submodules 731-735 may be implemented by hardware, software and/or a combination thereof. For example, the dual-layer knowledge graph module 730 and its submodules 731-735 may comprise a specific neural network structure implemented and run on various hardware platforms 760, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 760 used to implement the neural network structure is specifically configured based on factors such as the complexity of the neural network, the scale of the tasks (e.g., training time, input data scale, size of training dataset, etc.), and the desired performance.

For example, to deploy the dual-layer knowledge graph module 730 and its submodules 731-735 and/or any other neural network models described in FIGS. 1-6B onto hardware platform 760, the neural network based modules 730 and its submodules 731-735 may be optimized for deployment by converting it to a suitable format, such as ONNX or TensorRT, to improve performance and compatibility. Next, depending on the size and workload requirements for modules 730 and its submodules 731-735, hardware types may be chosen for deployment, e.g., processing capacity, GPU memory size, and/or the like. Frameworks and drivers for the chosen hardware 760 frameworks and drivers may thus be installed, such as PyTorch, TensorFlow, or CUDA, to support the hardware platform 760. Then, weights and parameters of the dual-layer knowledge graph module 730 and its submodules 731-735 may be loaded to the hardware 760. For large-scale deployments (e.g., with billions of weights for example), distributed computing frameworks may be used to handle model partitioning across multiple devices, e.g., hardware processors such as GPUs may be distributed on multiple devices, each handling a portion of weights of the model and therefore would undertake a portion of computational workload. In some embodiments, the dual-layer knowledge graph module 730 and its submodules 731-735 may be deployed as a service, then they may be integrated with an API endpoint, using tools like Flask, FastAPI, or a cloud platform serverless services, and is accessible by a remote user via a network.

In another embodiment, some or all of layers 741, 742, 743 and/or neurons 742, 745, 746, and operations there between such as activations 761, 762, and/or the like, of the dual-layer knowledge graph module 730 and its submodules 731-735 may be realized via one or more ASICs. For example, each neuron 742, 745 and 746 may be a hardware ASIC comprising a register, a microprocessor, and/or an input/output interface. For another example, operations among the neurons and layers may be implemented through an ASIC TPU. For yet another example, some operations among the neurons and layers such as a softmax operation, an activation function (such as a rectified linear unit (ReLU), sigmoid linear unit (SiLU), and/or the like) may be implemented by one or more ASICs.

For example, the dual-layer knowledge graph module 730 may generate, by at least one ASIC (such as a TPU, etc.) performing a multiplicative and/or accumulative operation for a neural network language model, a next token based at least in part on previously generated tokens, and in turn generate a natural language output representing the next-step action combining a sequence of generated tokens.

In one embodiment, the neural network based dual-layer knowledge graph module 730 and one or more of its submodules 731-735 may be trained by iteratively updating the underlying parameters (e.g., weights 751, 752, etc., bias parameters and/or coefficients in the activation functions 761, 762 associated with neurons) of the neural network based on the loss. For example, during forward propagation, the training data such as sets of (user query, groundtruth answer, sampled ontology, source documents) are fed into the neural network. The data flows through the network's layers 741, 742, with each layer performing computations based on its weights, biases, and activation functions until the output layer 743 produces the network's output 750. In some embodiments, output layer 743 produces an intermediate output on which the network's output 750 is based.

The output generated by the output layer 743 is compared to the expected output (e.g., a “ground-truth” such as the corresponding groundtruth answers or correct answers) from the training data, to compute a loss function that measures the discrepancy between the predicted output and the expected output. For example, the loss function may be, e.g., cross entropy, mean minimum squared error (MMSE), or a combination thereof. Given the loss, the negative gradient of the loss function is computed with respect to each weight of each layer individually. Such negative gradient is computed one layer at a time, iteratively backward from the last layer 743 to the input layer 741 of the neural network. These gradients quantify the sensitivity of the network's output to changes in the parameters. The chain rule of calculus is applied to efficiently calculate these gradients by propagating the gradients backward from the output layer 743 to the input layer 741.

In one embodiment, the neural network based dual-layer knowledge graph module 730 and one or more of its submodules 731-735 may be trained using policy gradient methods, also referred to as “reinforcement learning” methods. For example, instead of computing a loss based on a training output generated via a forward propagation of training data, the “policy” of the neural network model, which is a mapping from an input of the current states or observations of an environment the neural network model is operated at, to an output of action. Specifically, at each time step, a reward is allocated to an output of action generated by the neural network model. The gradients of the expected cumulative reward with respect to the neural network parameters are estimated based on the output of action, the current states of observations of the environment, and/or the like. These gradients guide the update of the policy parameters using gradient descent methods like stochastic gradient descent (SGD) or Adam. In this way, as the “policy” parameters of the neural network model may be iteratively updated while generating an output action as time progresses, the boundaries between training and inference are often less distinct compared to supervised learning-in other words, backward propagation and forward propagation may occur for both “training” and “inference” stages of the neural network mode.

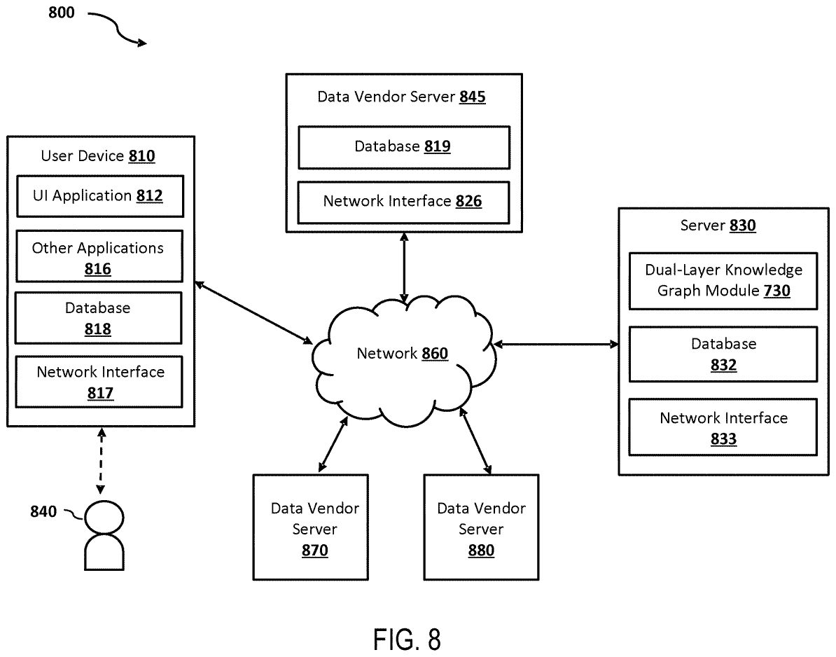

In some embodiments, dual-layer knowledge graph module 730 and its submodules 731-735 may be housed at a centralized server (e.g., computing device 700) or one or more distributed servers. For example, one or more of dual-layer knowledge graph module 730 and its submodules 731-735 may be housed at external server(s). The different modules may be communicatively coupled by building one or more connections through application programming interfaces (APIs) for each respective module. Additional network environment for the distributed servers hosting different modules and/or submodules may be discussed in FIG. 8.

During a backward pass, parameters of the neural network are updated backwardly from the last layer to the input layer (backpropagating) based on the computed negative gradient using an optimization algorithm to minimize the loss. The backpropagation from the last layer 743 to the input layer 741 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as generating an answer in response to a user query.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

In some implementations, to improve the computational efficiency of training a neural network model, “training” a neural network model such as an LLM may sometimes be carried out by updating the input prompt, e.g., the instruction to teach an LLM how to perform a certain task. For example, while the parameters of the LLM may be frozen, a set of tunable prompt parameters and/or embeddings that are usually appended to an input to the LLM may be updated based on a training loss during a backward pass. For another example, instead of tuning any parameter during a backward pass, input prompts, instructions, or input formats may be updated to influence their output or behavior. Such prompt designs may range from simple keyword prompts to more sophisticated templates or examples tailored to specific tasks or domains.

In general, the training and/or finetuning of an LLM can be computationally extensive. For example, GPT-3 has 175 billion parameters, and a single forward pass using an input of a short sequence can involve hundreds of teraflops (trillions of floating-point operations) of computation. Training such a model requires immense computational resources, including powerful GPUs or TPUs and significant memory capacity. Additionally, during training, multiple forward and backward passes through the network are performed for each batch of data (e.g., thousands of training samples), further adding to the computational load.

In general, the training process transforms the neural network into an “updated” trained neural network with updated parameters such as weights, activation functions, and biases. The trained neural network thus improves neural network technology in AI-assisted chatbots in various technical fields such as network issue diagnostics, healthcare, etc.

FIG. 8 is a simplified block diagram of a networked system 800 suitable for implementing the dual-layer knowledge graph framework 400 described in FIGS. 1-6B and other embodiments described herein. In one embodiment, system 800 includes the user device 810 which may be operated by user 840, data vendor servers 845, 870 and 880, server 830, and other forms of devices, servers, and/or software components that operate to perform various methodologies in accordance with the described embodiments. Exemplary devices and servers may include device, stand-alone, and enterprise-class servers which may be similar to the computing device 700 described in FIG. 7A, operating an OS such as a MICROSOFT® OS, a UNIX® OS, a LINUX® OS, or other suitable device and/or server-based OS. It can be appreciated that the devices and/or servers illustrated in FIG. 8 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 810, data vendor servers 845, 870 and 880, and the server 830 may communicate with each other over a network 860. User device 810 may be utilized by a user 840 (e.g., a driver, a system admin, etc.) to access the various features available for user device 810, which may include processes and/or applications associated with the server 830 to receive an output data anomaly report.

User device 810, data vendor server 845, and the server 830 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 800, and/or accessible over network 860.

User device 810 may be implemented as a communication device that may utilize appropriate hardware and software configured for wired and/or wireless communication with data vendor server 845 and/or the server 830. For example, in one embodiment, user device 810 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 810 of FIG. 8 contains a user interface (UI) application 812, and/or other applications 816, which may correspond to executable processes, procedures, and/or applications with associated hardware. For example, the user device 810 may receive a message indicating the generated answer in response to the user query from the server 830 and display the message via the UI application 812. In other embodiments, user device 810 may include additional or different modules having specialized hardware and/or software as required.

In one embodiment, UI application 812 may communicatively and interactively generate a UI for an AI agent implemented through the dual-layer knowledge graph module 730 (e.g., an LLM agent) at server 830. In at least one embodiment, a user operating user device 810 may enter a user utterance, e.g., via text or audio input, such as a question, uploading a document, and/or the like via the UI application 812. Such user utterance may be sent to server 830, at which dual-layer knowledge graph module 730 may generate a response via the process described in FIGS. 4, 5, 6A, and 6B. The dual-layer knowledge graph module 730 may thus cause a display of “Equinox studio city overview at xxx, and Santa Monica Fitness Club at xx . . . ” at UI application 812 and interactively update the display in real time with the user utterance.

In various embodiments, user device 810 includes other applications 816 as may be desired in particular embodiments to provide features to user device 810. For example, other applications 816 may include security applications for implementing client-side security features, programmatic client applications for interfacing with appropriate application programming interfaces (APIs) over network 860, or other types of applications. Other applications 816 may also include communication applications, such as email, texting, voice, social networking, and IM applications that allow a user to send and receive emails, calls, texts, and other notifications through network 860. For example, the other application 816 may be an email or instant messaging application that receives a prediction result message from the server 830. Other applications 816 may include device interfaces and other display modules that may receive input and/or output information. For example, other applications 816 may contain software programs for asset management, executable by a processor, including a graphical user interface (GUI) configured to provide an interface to the user 840 to view a generate answer.

User device 810 may further include database 818 stored in a transitory and/or non-transitory memory of user device 810, which may store various applications and data and be utilized during execution of various modules of user device 810. Database 818 may store user profile relating to the user 840, predictions previously viewed or saved by the user 840, historical data received from the server 830, and/or the like. In some embodiments, database 818 may be local to user device 810. However, in other embodiments, database 818 may be external to user device 810 and accessible by user device 810, including cloud storage systems and/or databases that are accessible over network 860.

User device 810 includes at least one network interface component 817 adapted to communicate with data vendor server 845 and/or the server 830. In various embodiments, network interface component 817 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 845 may correspond to a server that hosts database 819 to provide training datasets including sets of (user query, groundtruth answer, sampled ontology, source documents) to the server 830. The database 819 may be implemented by one or more relational database, distributed databases, cloud databases, and/or the like.

The data vendor server 845 includes at least one network interface component 826 adapted to communicate with user device 810 and/or the server 830. In various embodiments, network interface component 826 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 845 may send asset information from the database 819, via the network interface 826, to the server 830.

The server 830 may be housed with the dual-layer knowledge graph module 730 and its submodules described in FIG. 7A. In some implementations, dual-layer knowledge graph module 730 may receive data from database 819 at the data vendor server 845 via the network 860 to generate the knowledge graphs, answers, etc. The generated knowledge graphs and/or answers may also be sent to the user device 810 for review by the user 840 via the network 860.

In one embodiment, an AI agent implementing the dual-layer knowledge graph module 730 and its submodules described in FIG. 7A may be built based on an LLM as described in FIG. 7B. For example, the AI agent may be configured with one or more LLMs (e.g., each pretrained for a specific task or domain), a plurality of system prompts, and connected to external APIs to databases and applications (e.g., a search engine, a cloud service, an internal database, etc.).

In some embodiments, the AI agent implementing the dual-layer knowledge graph module 730 and its submodules described in FIG. 7A may be implemented as a cloud-based AI agent which may be accessed by user device 810 via a chatbot application, a web application, customer support or SaaS applications. In another implementation, a client-side AI agent component may be delivered from the server 830 to user device 810 for local installation such that the client-side AI agent may be installed and runs directly on the user's device. Such local AI agent on the user device 810 may be available offline to adapt to privacy-sensitive applications. In another implementation, the AI agent implementing the dual-layer knowledge graph module 730 and its submodules described in FIG. 7A may adopt a hybrid cloud and client-based structure to balance computing speed, cost and privacy. For example, a local AI agent may handle basic AI queries locally, but complex queries may be sent to server 830 to process.

The database 832 may be stored in a transitory and/or non-transitory memory of the server 830. In one implementation, the database 832 may store data obtained from the data vendor server 845. In one implementation, the database 832 may store parameters of the dual-layer knowledge graph module 730. In one implementation, the database 832 may store previously generated knowledge graphs, ontologies, and/or answers, and the corresponding input feature vectors.

In some embodiments, database 832 may be local to the server 830. However, in other embodiments, database 832 may be external to the server 830 and accessible by the server 830, including cloud storage systems and/or databases that are accessible over network 860.

The server 830 includes at least one network interface component 833 adapted to communicate with user device 810 and/or data vendor servers 845, 870 or 880 over network 860. In various embodiments, network interface component 833 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 860 may be implemented as a single network or a combination of multiple networks. For example, in various embodiments, network 860 may include the Internet or one or more intranets, landline networks, wireless networks, and/or other appropriate types of networks. Thus, network 860 may correspond to small scale communication networks, such as a private or local area network, or a larger scale network, such as a wide area network or the Internet, accessible by the various components of system 800.

### Example Work Flows

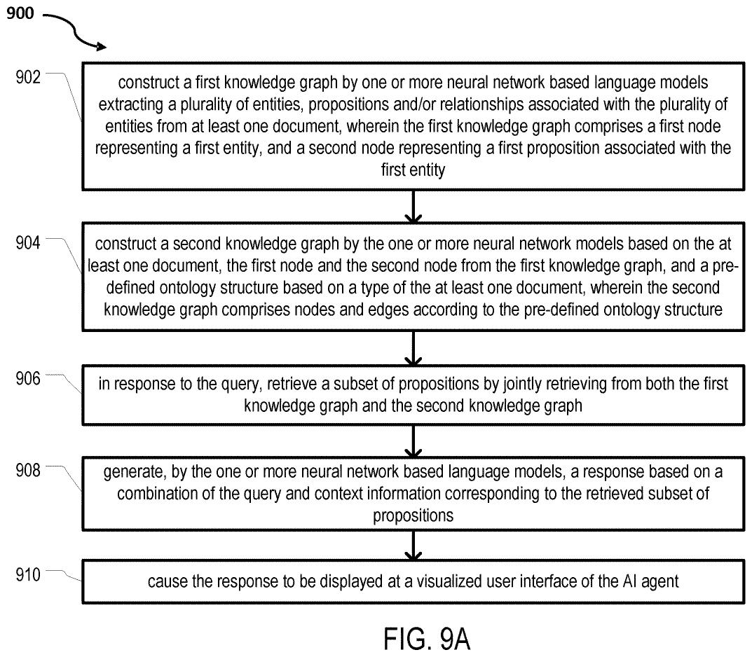

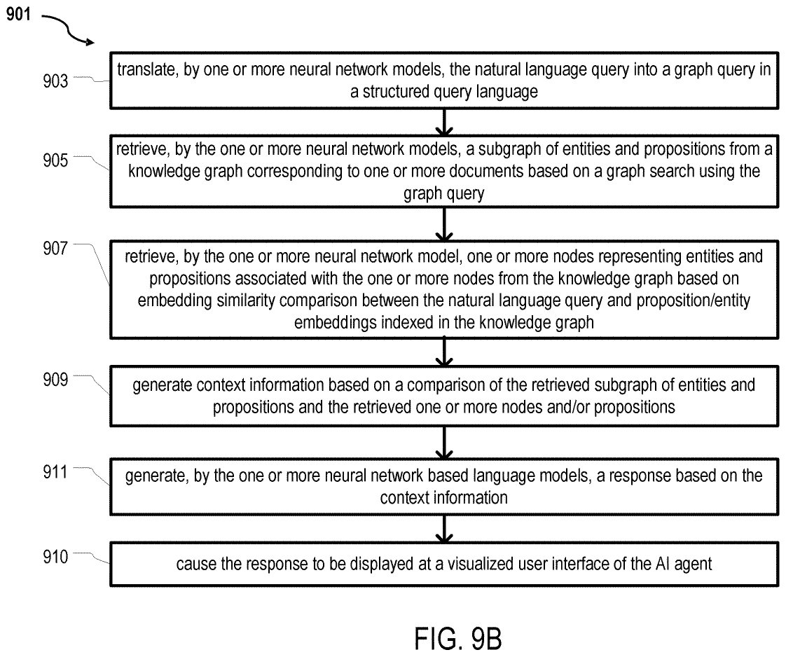

FIGS. 9A and 9B show example logic flow diagrams illustrating a method of answer generation the dual-layer knowledge graph framework 400 shown in FIGS. 4, 5, 6A, and 6B, according to some embodiments described herein. Method 900 describes an AI agent generating a response to a natural language query using a dual-layer knowledge graph, while method 900 describes AI agent generating a response to a natural language query using a dual-retrieval pipeline. In various embodiments, method 900 and method 901 may be performed jointly to generate an answer (e.g., response), or separately/independently to generate an answer.

One or more of the processes of methods 900 and 901 may be implemented, at least in part, in the form of executable code stored on non-transitory, tangible, machine-readable media that when run by one or more processors may cause the one or more processors to perform one or more of the processes. In some embodiments, methods 900 and 901 corresponds to the operation of the dual-layer knowledge graph module 730 (e.g., FIGS. 7A and 8) that performs retrieval(s) and answer generation based on dual-layer knowledge graphs.

In some embodiments, methods 900 and 901 are performed by a system such as computing device 700, user device 810, server 830, or another device or combination of devices. Inputs (e.g., user query) may be received via a data interface such as data interface 715, network interface 817, network interface 833, or via a data interface that is integrated with a device. For example, UI Application 812 may receive user inputs via a text input interface (e.g., keyboard), audio input (e.g., microphone), video interface (e.g., camera), or other interface for receiving user inputs (e.g., a mouse or touch display).

As illustrated, the methods 900 and 901 each includes a number of enumerated steps, but aspects of the methods 900 and 901 may include additional steps before, after, and in between the enumerated steps. In some aspects, one or more of the enumerated steps may be omitted or performed in a different order.

Method 900 is illustrated in steps 902-910, as shown in FIG. 9A.

At step 902, a first knowledge graph is constructed by one or more neural network based language models extracting a plurality of entities, propositions and/or relationships associated with the plurality of entities from at least one document. The first knowledge graph may include a first node representing a first entity, and a second node representing a first proposition associated with the first entity. For example, the first knowledge graph may be similar to the proposition-entity knowledge graph 210 constructed using the knowledge graph synthesis pipeline 200 described in the co-pending and commonly-owned U.S. nonprovisional application Ser. No. 19/006,731.

At step 904, a second knowledge graph is constructed by the one or more neural network models based on the at least one document, the first node and the second node from the first knowledge graph, and a pre-defined ontology structure based on a type of the at least one document. The second knowledge graph include nodes and edges according to the pre-defined ontology structure.

In some embodiments, all types of nodes in the first knowledge graph and the second knowledge graph are indexed. Node embeddings may be generated corresponding to the all types of nodes, and the node embeddings may be indexed.

At step 906, in response to the natural language query, a subset of propositions is retrieved by jointly retrieving from both the first knowledge graph and the second knowledge graph. In an example, the subset of propositions may be retrieved using a similar way that relevant propositions 304 are retrieved in the co-pending and commonly-owned U.S. nonprovisional application Ser. No. 19/006,731.

At step 908, a response is generated, by the one or more neural network based language models, based on a combination of the query and context information corresponding to the retrieved subset of propositions.

At step 910, the response is caused to be displayed at a visualized user interface of the AI agent.

Method 901 is illustrated in steps 903-910, as shown in FIG. 9B.

At step 903, the natural language query is translated, by one or more neural network models, into a graph query in a structured query language.

At step 905, a subgraph of entities and propositions is retrieved by the one or more neural network models from a knowledge graph (e.g., first knowledge graph and/or second knowledge graph) corresponding to one or more documents based on a graph search using the graph query. In an example, the subgraph may be generated using a similar way that proposition entity subgraph 306 is retrieved in the co-pending and commonly-owned U.S. nonprovisional application Ser. No. 19/006,731.

At step 907, one or more nodes representing entities and propositions associated with the one or more nodes are retrieved, by the one or more neural network model, from the knowledge graph based on embedding similarity comparison between the natural language query and proposition/entity embeddings indexed in the knowledge graph. In an example, the nodes may be retrieved using a similar way that proposition linked to query entity in subgraph 308 is retrieved in the co-pending and commonly-owned U.S. nonprovisional application Ser. No. 19/006,731.

At step 909, context information is generated based on a comparison of the retrieved subgraph of entities and propositions and the retrieved one or more nodes and/or propositions.

At step 911, a response is generated, by the one or more neural network based language models, based on the context information based on the comparison.

At step 910, the response is caused to be displayed at a visualized user interface of the AI agent.

In some embodiments, method 900 further includes, translating, by the one or more neural network models, the natural language query into a graph query in a structured query language; and retrieving, by the one or more neural network models, a subgraph of entities and propositions from the first knowledge graph or the second knowledge graph based on a graph search using the graph query. Method 900 may further include retrieving, by the one or more neural network model, one or more nodes representing entities and propositions associated with the one or more nodes from the knowledge graph based on embedding similarity comparison between the natural language query and proposition/entity embeddings indexed in the first knowledge graph or the second knowledge graph; and generating context information based on a comparison of the retrieved subgraph of entities and propositions and the retrieved one or more nodes and/or propositions. In some embodiments, the retrieving of the subgraph of entities and propositions includes, extracting entities from the natural language query; performing entity resolution on the extracted entities to consolidate duplicated entities and generate a resolved query with unique entities; and converting the resolved query to an intermediate output (e.g., Cypher query) for the retrieving in the first knowledge graph or the second knowledge graph.

In some embodiments, method 900 further includes selecting a set of top-ranking propositions and all entities linked to the set of top-ranking propositions from the retrieved propositions; constructing a second subgraph with the set of top-ranking propositions and all the entities linked to the set of top-ranking propositions; and performing K-hop traversal in the second subgraph using a set of top-ranking entities from the entities linked to the set of top-ranking propositions as starting points to collect a selected set of propositions. In some embodiments, method 900 further includes filtering the selected set of propositions based on a relevance to the natural language query to form a set of filtered propositions, and/or retrieving a set of document chunks mapped to the set of filtered propositions as part of the context information.

In some embodiments, method 900 may further include generating, by the one or more neural network based language models, the response based on second context information based on the comparison.

In some embodiments, method 900 may further include generating a proposition embedding for first proposition, and mapping the first proposition to a document chunk of the at least one document.

In some embodiments, method 901 may be performed in addition to method 900 to generate an answer. For example, steps 903, 905,907, 909 may be performed between steps 906 and 908. For example, the response may be generated based on context information obtained from step 906 and/or step 909.

In some embodiments, methods 900 and 901 are applicable in a variety of applications. For example, the task request received by a neural network model (e.g., GPT-4o or GPT-5) may relate to a diagnostic request in view of a medical record in a healthcare system, a curriculum designing request in an online education system, a code generation request in a software development system, a writing and/or editing request in a content generation system, an IT diagnostic request in an IT customer service support system, a navigation request in a robotic and autonomous system, and/or the like. By performing method 900, the neural network based artificial agent may improve technology in the respective technical field in healthcare and diagnostics, education and personalized learning, software development and code assistance, content creation, autonomous system (such as autonomous driving, etc.), and/or the like.

For example, when the task query includes a query to identify an information technology (IT) anomaly relating to a usage of an IT component such as a network gateway, a router, an online printer, and/or the like, by performing methods 900 and 901 at an environment of a local area network (LAN), the neural network based artificial agent may receive an observation from the environment at which the next-step action is executed, and determine that the observation representing an information technology anomaly (e.g., a router failure, an unauthorized access attempt, a domain name system anomaly, and/or the like). In some implementations, the neural network based artificial agent may cause an alert relating to the information technology anomaly to be displayed at a visualized user interface. In this way, IT anomalies may be detected and alerted using the neural network based artificial agent in an efficient manner so as to improve network support technology.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method of an artificial intelligence (AI) agent generating a response to a natural language query using a dual-layer knowledge graph, the method comprising:
constructing a first knowledge graph by one or more neural network based language models extracting a plurality of entities, propositions and/or relationships associated with the plurality of entities from at least one document, wherein the first knowledge graph comprises a first node representing a first entity, and a second node representing a first proposition associated with the first entity;
constructing a second knowledge graph by the one or more neural network models based on the at least one document, the first node and the second node from the first knowledge graph, and a pre-defined ontology structure based on a type of the at least one document, wherein the second knowledge graph comprises nodes and edges according to the pre-defined ontology structure;
in response to the natural language query, retrieving a subset of propositions by jointly retrieving from both the first knowledge graph and the second knowledge graph;
generating, by the one or more neural network based language models, a response based on a combination of the query and context information corresponding to the retrieved subset of propositions; and
causing the response to be displayed at a visualized user interface of the AI agent.

2. The method of claim 1, further comprising:
translating, by the one or more neural network models, the natural language query into a graph query in a structured query language;
retrieving, by the one or more neural network models, a subgraph of entities and propositions from the first knowledge graph or the second knowledge graph based on a graph search using the graph query;
retrieving, by the one or more neural network model, one or more nodes representing entities and propositions associated with the one or more nodes from the knowledge graph based on embedding similarity comparison between the natural language query and proposition/entity embeddings indexed in the first knowledge graph or the second knowledge graph; and
generating context information based on a comparison of the retrieved subgraph of entities and propositions and the retrieved one or more nodes and/or propositions.

3. The method of claim 2, further comprising generating, by the one or more neural network based language models, the response based on second context information based on the comparison.

4. The method of claim 1, further comprising:
indexing all types of nodes in the first knowledge graph and the second knowledge graph;
generating node embeddings corresponding to the all types of nodes; and
indexing the node embeddings.

5. The method of claim 1, further comprising:
generating a proposition embedding for first proposition; and
mapping the first proposition to a document chunk of the at least one document.

6. The method of claim 2, wherein the retrieving of the subgraph of entities and propositions includes:
extracting entities from the natural language query;
performing entity resolution on the extracted entities to consolidate duplicated entities and generate a resolved query with unique entities; and
converting the resolved query to an intermediate output for the retrieving in the first knowledge graph or the second knowledge graph.

7. The method of claim 2, further comprising:
selecting a set of top-ranking propositions and all entities linked to the set of top-ranking propositions from the retrieved propositions;
constructing a second subgraph with the set of top-ranking propositions and all the entities linked to the set of top-ranking propositions; and
performing K-hop traversal in the second subgraph using a set of top-ranking entities from the entities linked to the set of top-ranking propositions as starting points to collect a selected set of propositions.

8. The method of claim 7, further comprising filtering the selected set of propositions based on a relevance to the natural language query to form a set of filtered propositions.

9. The method of claim 8, further comprising retrieving a set of document chunks mapped to the set of filtered propositions as part of the context information.

10. A system for an artificial intelligence (AI) agent generating a response to a natural language query using a dual-layer knowledge graph, the system comprising:
a memory that stores one or more neural network based model and a plurality of processor executable instructions;
a communication interface that receives the natural language query; and
one or more hardware processors that read and execute the plurality of processor-executable instructions from the memory, wherein the plurality of processor-executable instructions are configurable to cause the system to perform operations comprising:
constructing a first knowledge graph by the one or more neural network based language models extracting a plurality of entities, propositions and/or relationships associated with the plurality of entities from at least one document, wherein the first knowledge graph comprises a first node representing a first entity, and a second node representing a first proposition associated with the first entity;
constructing a second knowledge graph by the one or more neural network models based on the at least one document, the first node and the second node from the first knowledge graph, and a pre-defined ontology structure based on a type of the at least one document, wherein the second knowledge graph comprises nodes and edges according to the pre-defined ontology structure;
in response to the natural language query, retrieving a subset of propositions by jointly retrieving from both the first knowledge graph and the second knowledge graph;
generating, by the one or more neural network based language models, a response based on a combination of the query and context information corresponding to the retrieved subset of propositions; and
causing the response to be displayed at a visualized user interface of the AI agent.

11. The system of claim 10, wherein the operations further include:
translating, by the one or more neural network models, the natural language query into a graph query in a structured query language;
retrieving, by the one or more neural network models, a subgraph of entities and propositions from the first knowledge graph or the second knowledge graph based on a graph search using the graph query;
retrieving, by the one or more neural network model, one or more nodes representing entities and propositions associated with the one or more nodes from the knowledge graph based on embedding similarity comparison between the natural language query and proposition/entity embeddings indexed in the first knowledge graph or the second knowledge graph; and
generating context information based on a comparison of the retrieved subgraph of entities and propositions and the retrieved one or more nodes and/or propositions.

12. The system of claim 11, wherein the operations further include generating, by the one or more neural network based language models, the response based on second context information based on the comparison.

13. The system of claim 10, wherein the operations further include:
indexing all types of nodes in the first knowledge graph and the second knowledge graph;
generating node embeddings corresponding to the all types of nodes; and
indexing the node embeddings.

14. The system of claim 10, wherein the operations further include:
generating a proposition embedding for first proposition; and
mapping the first proposition to a document chunk of the at least one document.

15. The system of claim 11, wherein the retrieving of the subgraph of entities and propositions includes:
extracting entities from the natural language query;
performing entity resolution on the extracted entities to consolidate duplicated entities and generate a resolved query with unique entities; and
converting the resolved query to an intermediate output for the retrieving in the first knowledge graph or the second knowledge graph.

16. The system of claim 11, wherein the operations further include:
selecting a set of top-ranking propositions and all entities linked to the set of top-ranking propositions from the retrieved propositions;
constructing a second subgraph with the set of top-ranking propositions and all the entities linked to the set of top-ranking propositions; and
performing K-hop traversal in the second subgraph using a set of top-ranking entities from the entities linked to the set of top-ranking propositions as starting points to collect a selected set of propositions.

17. The system of claim 16, wherein the operations further include filtering the selected set of propositions based on a relevance to the natural language query to form a set of filtered propositions.

18. The system of claim 17, wherein the operations further include retrieving a set of document chunks mapped to the set of filtered propositions as part of the context information.

19. A non-transitory machine-readable medium comprising a plurality of instructions, executable by one or more processors, wherein the plurality of instructions are configurable to cause the one or more processors to perform operations comprising:
constructing a first knowledge graph by one or more neural network based language models extracting a plurality of entities, propositions and/or relationships associated with the plurality of entities from at least one document;
wherein the first knowledge graph comprises a first node representing a first entity, and a second node representing a first proposition associated with the first entity;
constructing a second knowledge graph by the one or more neural network models based on the at least one document, the first node and the second node from the first knowledge graph, and a pre-defined ontology structure based on a type of the at least one document, wherein the second knowledge graph comprises nodes and edges according to the pre-defined ontology structure;
in response to a natural language query, retrieving a subset of propositions by jointly retrieving from both the first knowledge graph and the second knowledge graph;
generating, by the one or more neural network based language models, a response based on a combination of the query and context information corresponding to the retrieved subset of propositions; and
causing the response to be displayed at a visualized user interface of the AI agent.

20. The non-transitory machine-readable medium of claim 19, wherein the operations further include:
translating, by the one or more neural network models, the natural language query into a graph query in a structured query language;
retrieving, by the one or more neural network models, a subgraph of entities and propositions from the first knowledge graph or the second knowledge graph based on a graph search using the graph query;
retrieving, by the one or more neural network model, one or more nodes representing entities and propositions associated with the one or more nodes from the knowledge graph based on embedding similarity comparison between the natural language query and proposition/entity embeddings indexed in the first knowledge graph or the second knowledge graph; and
generating context information based on a comparison of the retrieved subgraph of entities and propositions and the retrieved one or more nodes and/or propositions.
